(19) United States
(12) Patent Application Publication
(10) Pub. No.: US 2012/0026892 A1
(43) Pub. Date: Feb. 2, 2012

(54) BASE STATION APPARATUS AND TERMINAL APPARATUS

(75) Inventors: Seigo Nakao, Kanagawa (JP); Akihiko Nishio, Kanagawa (JP); Ayako Horiuchi, Kanagawa (JP); Daichi Imamura, Kanagawa (JP)

(73) Assignee: PANASONIC CORPORATION, Osaka (JP)

(21) Appl. No.: 13/263,171

(22) PCT Filed: Apr. 23, 2010
(86) PCT No.: PCT/JP2010/002956

§ 371 Date: Oct. 6, 2011

(30) Foreign Application Priority Data
Apr. 24, 2009 (JP) 2009-106332

(51) Int. Cl. H04W 24/00; H04W 72/04

(52) U.S. Cl. 370/242; 370/329

(57) ABSTRACT

A base station apparatus and terminal apparatus with a configuration which achieves highly flexible retransmission control while preventing increases in the uplink control channel overhead. In the base station (100), a control unit (101) configures a bundling unit band group including first and second downlink unit bands, and a mapping unit (108) maps initial transmission data to the first and second downlink unit bands as well as maps retransmission data to a third downlink unit band excluding the downlink unit bands of the bundling unit band group. Further, in the terminal (200), a bundling control unit (212) transmits a response signal for the initial transmission data with the constituent resources of an uplink control channel provided in an uplink unit band and linked to the downlink control channels of the downlink unit bands used to transmit the initial transmission data, and transmits a response signal for the retransmission data using resources different from that of the response signal for the initial transmission data.

### TECHNICAL FIELD

The present invention relates to a base station apparatus and terminal apparatus.

### BACKGROUND ART

3GPP LTE adopts OFDMA (Orthogonal Frequency Division Multiple Access) as a downlink communication scheme. In a radio communication system to which 3GPP LTE is applied, a base station transmits a synchronization signal (Synchronization Channel: SCH) and a broadcast signal (Broadcast Channel: BCH) using predetermined communication resources. A terminal secures synchronization with the base station by catching the SCH first. The terminal then reads BCH information and thereby acquires parameters (e.g. frequency bandwidth) peculiar to the base station (see Non-Patent Literatures 1, 2, 3).

Furthermore, after completing the acquisition of the parameters peculiar to the base station, the terminal requests the base station for a connection and thereby establishes communication with the base station. The base station transmits control information to the terminal with which communication is established via a PDCCH (Physical Downlink Control CHannel) as required.

The terminal then makes a “blind detection” on a plurality of pieces of control information included in the received PDCCH signal. That is, the control information includes a CRC (Cyclic Redundancy Check) portion and this CRC portion is masked with a terminal ID of the destination terminal in the base station. Therefore, the terminal cannot decide whether the control information is directed to the terminal or not until the terminal demasks the CRC portion of the received control information using the terminal ID of the terminal. In this blind detection, when the demasking result shows that the CRC calculation results is OK, the control information is decided to be directed to the terminal.

Furthermore, 3GPP LTE applies ARQ (Automatic Repeat reQuest) to downlink data from the base station to the terminal. That is, the terminal feeds back a response signal indicating an error detection result of the downlink data to the base station. The terminal performs a CRC on the downlink data and feeds back ACK (Acknowledgment) when CRC=OK (no error) or NACK (Negative Acknowledgment) when CRC=NG (error present) to the base station as a response signal. An uplink control channel such as a PUCCH (Physical Uplink Control Channel) is used to feed back this response signal (that is, ACK/NACK signal).

When the received response signal indicates NACK, the base station transmits retransmission data to the terminal. In this case, a New Data Indicator (NDI) bit in the downlink assignment control signal is set to 0 and the retransmission data and assignment control signal are transmitted in the same subframe. Furthermore, this retransmission is performed through so-called Incremental Redundancy (IR) (see Non-Patent Literature 4). To be more specific, as shown in Non-Patent Literatures 1 to 3, the base station retransmits data using an optimum Redundancy Version (RV) according to the retransmission count. That is, upon retransmission of data, the base station sets the NDI bit to 0 and likewise sets the RV number used for the retransmission data in the downlink assignment control signal and transmits the downlink assignment control signal obtained in the same subframe as that of the downlink retransmission data. The NDI bit in the downlink assignment control signal transmitted in the same subframe as that of the initial transmission data is assumed to be 1.

Here, the above described control information transmitted from the base station includes resource assignment information including resource information or the like assigned to the terminal by the base station. The above described PDCCH is used to transmit the control information. The PDCCH is comprised of one or a plurality of L1/L2 CCHs (L1/L2 Control Channel). Each L1/L2 CCH is comprised of one or a plurality of CCEs (Control Channel Elements). That is, the CCE is a base unit when control information is mapped to the PDCCH. Furthermore, when one L1/L2 CCH is comprised of a plurality of CCEs, a plurality of continuous CCEs are assigned to the L1/L2 CCH. The base station assigns an L1/L2 CCH to a resource assignment target terminal according to the number of CCEs necessary to notify control information to the resource assignment target terminal. The base station then transmits the control information mapped to physical resources corresponding to the CCEs of the L1/L2 CCH.

Furthermore, here, the CCEs are associated with component resources of a PUCCH on a one-by-one basis. Therefore, the terminal that has received the L1/L2 CCH can implicitly identify the PUCCH component resources corresponding to the CCEs making up this L1/L2 CCH and transmits a response signal to the base station using the identified resources. Thus, the downlink communication resources are used efficiently.

A plurality of response signals transmitted from a plurality of terminals are spread on the time axis by a ZAC (Zero Auto-correlation) sequence having Zero Auto-correlation characteristics, Walsh sequence and DFT (Discrete Fourier Transform) sequence and code-multiplexed within a PUCCH as shown in FIG. 1. In FIG. 1 (W₀, W₁, W₂, W₃) represents a Walsh sequence having a sequence length of 4 and (F₀, F₁, F₂) represents a DFT sequence having a sequence length of 3. As shown in FIG. 1, in the terminal, a response signal of ACK or NACK is primary-spread within 1 SC-FDMA symbol by a ZAC sequence (sequence length 12) on the frequency axis first. Next, the primary-spread response signals are associated with W₀ to W₃, F₀ to F₃ respectively and subjected to IFFT (Inverse Fast Fourier Transform). The response signal spread by the ZAC sequence having a sequence length of 12 on the frequency axis is transformed into the ZAC sequence having a sequence length of 12 on the time axis through IFFT. The signal after the IFFT is further secondary-spread using a Walsh sequence (sequence length 4) and DFT sequence (sequence length 3).

Furthermore, standardization of 3GPP LTE-advanced has been started which realizes still faster communication than 3GPP LTE. A 3GPP LTE-advanced system (hereinafter also referred to as “LIE-A system”) follows the 3GPP LTE system (hereinafter also referred to as “LTE system”). In order to realize a downlink transmission rate of a maximum of 1 Gbps or above, 3GPP LTE-advanced is expected to introduce base stations and terminals capable of communicating at a wideband frequency of 40 MHz or above.

In an LTE-A system, to realize communication at an ultra-high speed several times as fast as the transmission rate in an LTE system and backward compatibility with the LTE system simultaneously, a band assigned to the LTE-A system is divided into “unit bands” of 20 MHz or less which is a support bandwidth of the LTE system. That is, the “unit band” is a band having a width of maximum 20 MHz and defined as a base unit of a communication band. Furthermore, the “unit band” in a downlink (hereinafter referred to as “downlink unit band”) may be defined as a band divided by downlink frequency band information in a BCH broadcast from the base station or by a spreading width when the downlink control channel (PDCCH) is arranged by being spread in the frequency domain. Furthermore, the “unit band” in an uplink (hereinafter referred to as “uplink unit band”) may be defined as a band divided by uplink frequency band information in a BCH broadcast from the base station or as a base unit of a communication band of 20 MHz or less including a PUSCH (Physical Uplink Shared CHannel) region near the center and PUCCHs for LTE at both ends. Furthermore, in 3GPP LTE-Advanced, the “unit band” may also be expressed as component carrier(s) in English.

The LTE-A system supports communication using a band that bundles several unit bands, so-called “carrier aggregation.” In the LTE-A system, studies are being carried out on carrier aggregation in which the number of unit bands set for an arbitrary LTE-A system supporting terminal (hereinafter referred to as “LTE-A terminal”) is common between the uplink and downlink, so-called “symmetric carrier aggregation” and carrier aggregation in which the number of unit bands set for an arbitrary LIE-A terminal differs between the uplink and downlink, so-called “asymmetric carrier aggregation.” The latter is suitable for use in a case where throughput requirements for the uplink are different from throughput requirements for the downlink. Furthermore, cases are also expected to be supported where the number of unit bands is asymmetric between the uplink and downlink, and the frequency bandwidth differs from one unit band to another.

FIG. 2 is a diagram illustrating asymmetric carrier aggregation and a control sequence applicable to individual terminals. FIG. 2 shows an example where bandwidths and the number of unit bands are symmetric between the uplink and downlink of the base station.

In FIG. 2, a setting (configuration) is made for terminal 1 so as to perform carrier aggregation using two downlink unit bands and one uplink unit band on the left side, whereas although a setting is made for terminal 2 so as to use two downlink unit bands identical to those of terminal 1, a setting is made in uplink communication so as to use the uplink unit band on the right side.

Focusing attention on terminal 1, signals are transmitted/received between an LTE-A base station and an LTE-A terminal making up an LTE-A system according to the sequence diagram shown in FIG. 2A. As shown in FIG. 2A, (1) terminal 1 establishes synchronization with the downlink unit band on the left side at a start of communication with the base station and reads information of the uplink unit band which forms a pair with the downlink unit band on the left side from a broadcast signal called “SIB 2 (System Information Block Type 2).” (2) Using this uplink unit band, terminal 1 starts communication with the base station by transmitting, for example, a connection request to the base station. (3) Upon deciding that a plurality of downlink unit bands need to be assigned to the terminal, the base station commands the terminal to add downlink unit bands. In this case, however, the number of uplink unit bands does not increase and terminal 1 which is an individual terminal starts asymmetric carrier aggregation.

### CITATION LIST

### Non-Patent Literature

NPL 1
3GPP TS 36.211 V8.6.0, “Physical Channels and Modulation (Release 8),” March 2009
NPL 2
3GPP TS 36.212 V8.6.0, “Multiplexing and channel coding (Release 8),” March 2009
NPL 3
3GPP TS 36.213 V8.6.0, “Physical layer procedures (Release 8),” March 2009
NPL 4
P. Frenger, S. Parkvall, and E. Dahlman, “Performance comparison of HARQ with chase combining and incremental redundancy for HSDPA,” Proc. IEEE VTC'01-Fall, October 2001

### SUMMARY OF INVENTION

### Technical Problem

By the way, LTE-A is studying the following two modes as a method for transmitting a response signal. That is, a first mode is a so-called non-bundling mode in which response signals are individually transmitted to a plurality of pieces of data transmitted in a plurality of downlink unit bands. In the so-called non-bundling mode, a plurality of response signals are assigned resources differing in at least one of frequency and sign, and simultaneously transmitted. The non-bundling mode may also be called “multi-code transmission mode.” Furthermore, a second mode is so-called ACK/NACK bundling (hereinafter, simply described as “bundling”) in which a plurality of response signals for a plurality of pieces of data transmitted in a plurality of downlink unit bands are bundled into one signal and transmitted. In bundling, the terminal calculates AND (that is, Logical AND) between a plurality of ACK/NACK signals to be transmitted and feeds back the calculation result as a “bundled ACK/NACK signal” to the base station.

When the above described carrier aggregation is applied to the terminal, ARQ is controlled as follows. First, a case with bundling will be described with reference to the left figure of FIG. 3. As shown in FIG. 3, when a unit band group made up of downlink unit bands 1 and 2, and uplink unit band 1 is set for the terminal, downlink resource assignment information is transmitted from the base station to the terminal via respective PDCCHs of downlink unit bands 1 and 2, and downlink data is then transmitted using resources corresponding to the downlink resource assignment information. Not only an ACK/NACK signal for the downlink data transmitted in downlink unit band 2 but also an ACK/NACK signal for the downlink data transmitted in downlink unit band 1 is transmitted using a PUCCH of uplink unit band 2 corresponding to downlink unit band 2.

When the terminal succeeds in receiving both of the two pieces of downlink data (CRC=OK), the terminal calculates AND between ACK(=1) for downlink unit band 1 and ACK(=1) for downlink unit band 2 and transmits “1” (that is, ACK) as the calculation result to the base station as a bundled ACK/NACK signal. Furthermore, when the terminal succeeds in receiving downlink data in downlink unit band 1 and fails to receive downlink data in downlink unit band 2, the terminal calculates AND between ACK(=1) for the downlink unit band and NACK(=0) for downlink unit band 2 and transmits “0” (that is, NACK) to the base station as a bundled ACK/NACK signal. Similarly, when the terminal fails to receive both of the two pieces of downlink data, the terminal calculates AND between NACK(=0) and NACK(=0) and feeds back “0” (that is, NACK) to the base station as a bundled ACK/NACK signal.

Thus, with bundling, the terminal transmits only one ACK to the base station as a bundled ACK/NACK signal only when succeeding in receiving all of the plurality of pieces of downlink data transmitted to the terminal and transmits only one NACK to the base station as a bundled ACK/NACK signal when failing to receive even one piece of downlink data, and can thereby reduce overhead in the uplink control channel. The terminal side transmits a bundled ACK/NACK signal using PUCCH resources having, for example, the smallest frequency or identification number (Index) from among respective PUCCH resources corresponding to a plurality of CCEs occupied by a plurality of received downlink control signals.

By contrast, in the non-bundling mode, response signals for their respective pieces of downlink data are individually transmitted as shown in the right figure of FIG. 3. However, the right figure of FIG. 3 shows an example when symmetric carrier aggregation is adopted where the number of downlink unit bands is the same as the number of uplink unit bands making up the unit band group set in a certain terminal.

However, the above described two modes have advantages and disadvantages. That is, with bundling, the terminal calculates logical AND of response signals corresponding to the data of a plurality of downlink unit bands and transmits the bundling result. First, this makes it possible to keep single carrier characteristics of a transmission waveform on the terminal side as in the case of the LTE system, and secondly, since only one PUCCH resource is occupied, it is possible to reduce inter-code interference with other signals constituting a capacity limit in PUCCHs. However, it is not possible to individually transmit success/failure in reception of data in the plurality of downlink unit bands to the base station and if the terminal side fails to receive even one piece of downlink data, the terminal returns NACK to the base station, and therefore the base station cannot help but retransmit all data. That is, while bundling has a merit of being able to reduce inter-code interference or the like, bundling has a problem that the flexibility of retransmission control deteriorates.

On the other hand, in the non-bundling mode, the flexibility of retransmission control is high but overhead in the uplink control channel is greater than that of bundling.

It is an object of the present invention to provide a base station apparatus and terminal apparatus that realize retransmission control with high flexibility while preventing overhead of an uplink control channel from increasing.

### Solution to Problem

A base station apparatus according to an aspect of the present invention is a base station that communicates with a terminal using a unit band group made up of N (N is a natural number equal to 2 or greater) downlink unit bands and uplink unit bands, and adopts a configuration including a control section that sets a bundling unit band group from among the N downlink unit bands and a mapping section that maps initial transmission data in downlink data to the downlink unit bands of the bundling unit band group and also maps retransmission data to downlink unit bands other than the downlink unit band of the bundling unit band group out of the N downlink unit bands.

A terminal apparatus according to an aspect of the present invention is a terminal apparatus that communicates with a base station using a unit band group made up of N (N is a natural number equal to 2 or greater) downlink unit bands and uplink unit bands and transmits a response signal based on an error detection result of downlink data arranged in a downlink unit band through an uplink control channel of an uplink unit band corresponding to the downlink unit band, including a control information receiving section that receives downlink assignment control information transmitted through downlink control channels of the plurality of downlink unit bands, a downlink data receiving section that receives the downlink data transmitted through a downlink data channel indicated by the downlink assignment control information, an error detection section that detects a reception error of the received downlink data, a decision section that decides whether the downlink data received in each downlink unit band is initial transmission data or retransmission data, and a response control section that controls transmission of a response signal used for retransmission control of the downlink data in the base station based on the error detection result obtained in the error detection section, success/failure in the reception of the downlink assignment control information and the decision result, wherein the response control section transmits a response signal for the initial transmission data using component resources of an uplink control channel provided in the uplink unit band associated with the downlink control channel of the downlink unit band in which the initial transmission data is transmitted and transmits a response signal for the retransmission data using resources different from those of a response signal for the initial transmission data.

### Advantageous Effects of Invention

According to the present invention, it is possible to provide a base station apparatus and terminal apparatus that realize retransmission control with high flexibility while preventing overhead of an uplink control channel from increasing.

### BRIEF DESCRIPTION OF DRAWINGS

FIG. 1 is a diagram illustrating a method of spreading a response signal and reference signal;

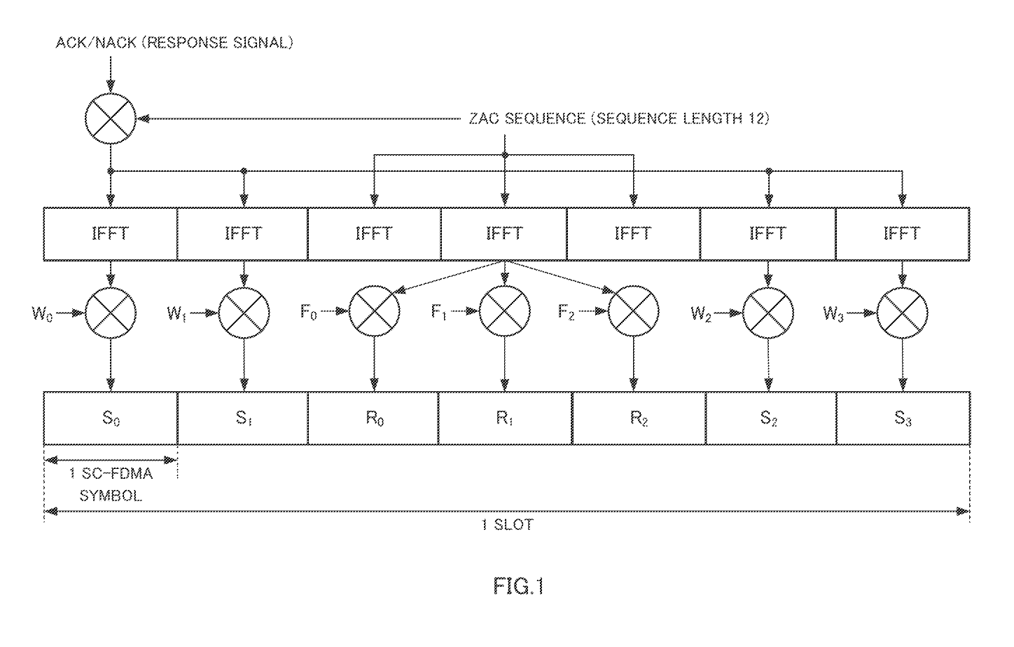

FIG. 2 is a diagram illustrating asymmetric carrier aggregation applied to individual terminals and a control sequence thereof;

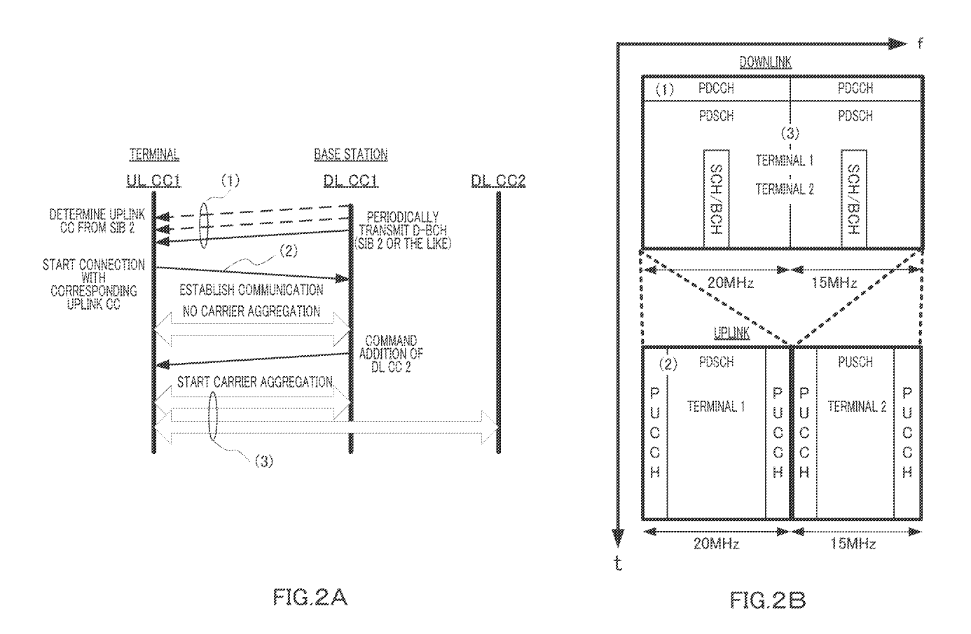

FIG. 3 is a diagram illustrating ARQ control when carrier aggregation is applied to a terminal;

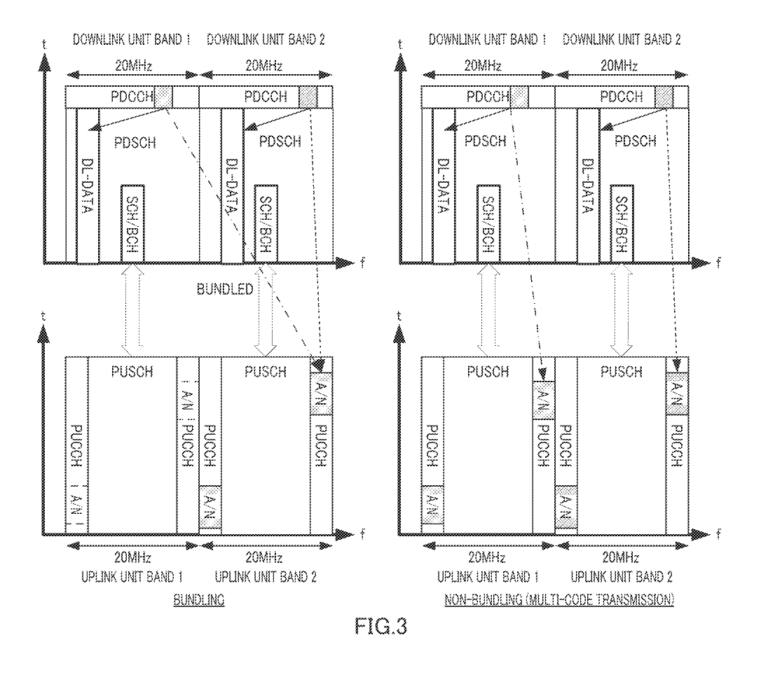

FIG. 4 is a block diagram showing a configuration of a base station according to Embodiment 1 of the present invention;

FIG. 5 is a block diagram showing a configuration of a terminal according to Embodiment 1 of the present invention;

FIG. 6 is a diagram illustrating operations of the base station and terminal;

FIG. 7 is a diagram illustrating a relationship between a type of data transmitted in a downlink unit band (that is, initial transmission data or retransmission data) and a type of response signal (that is, response signal using bundling or response signal using non-bundling);

FIG. 8 is a block diagram illustrating a configuration of a base station according to Embodiment 2 of the present invention;

FIG. 9 is a diagram illustrating a configuration of a terminal according to Embodiment 2 of the present invention;

FIG. 10 is a diagram illustrating operations of the base station and terminal;

FIG. 11 is a block diagram showing a configuration of a base station according to Embodiment 3 of the present invention;

FIG. 12 is a block diagram showing a configuration of a terminal according to Embodiment 3 of the present invention;

FIG. 13 is a diagram illustrating operations of the base station and terminal; and

FIG. 14 is a diagram illustrating operations of the base station and terminal.

### DESCRIPTION OF EMBODIMENTS

The present inventor noticed the fact that the problem with deterioration in flexibility of retransmission control with bundling is more emphasized in bundling response signals for a plurality of pieces of downlink data having significantly different error rates or significantly different degrees of emergency.

Furthermore, the present inventor also noticed the presence of high correlation between a data retransmission count and an error rate. To be more specific, while the error rate of initial transmission data is on the order of 10%, the error rate of retransmission data decreases even to several % with a gain of IR (Incremental Redundancy) or the like. The error rate further decreases as the retransmission count increases. By the way, the data retransmission count can be decided from an NDI (New Data Indicator) bit and RV (Redundancy Version) bit included in an assignment control signal of downlink data.

The present inventor then performed retransmission control (response signal transmission control in particular) separately for initial transmission data and retransmission data having different error rates and came up with the present invention capable of making the most of advantages of both bundling and non-bundling.

Hereinafter, embodiments of the present invention will be described in detail with reference to the accompanying drawings. The same components among the embodiments will be assigned the same reference numerals and overlapping descriptions thereof will be omitted.

### Embodiment 1

### Overview of Communication System

A communication system including base station 100 and terminal 200, which will be described later, performs communication using N (N is a natural number equal to 2 or greater) uplink unit bands and N downlink unit bands associated with the N uplink unit bands, that is, communication through symmetric carrier aggregation peculiar to terminal 200. The N uplink unit bands and N downlink unit bands are a “unit band group” set for terminal 200. Furthermore, this communication system also includes a terminal that has no capability to perform communication through carrier aggregation unlike terminal 200 and performs communication through one downlink unit band and one uplink unit band associated therewith (that is, communication without carrier aggregation).

Therefore, base station 100 is configured to be able to support both communication through symmetric carrier aggregation and communication without carrier aggregation.

Furthermore, it is also possible to perform communication without carrier aggregation between base station 100 and terminal 200 depending on resource assignment to terminal 200 by base station 100.

Furthermore, when communication without carrier aggregation is performed, this communication system performs ARQ in a conventional way and on the other hand, it also adopts bundling of response signals in ARQ when communication through carrier aggregation is performed. That is, this communication system is, for example, an LTE-A system, base station 100 is, for example, an LTE-A base station and terminal 200 is, for example, an LTE-A terminal. Furthermore, the terminal having no capability to perform communication through carrier aggregation is, for example, an LTE terminal.

Furthermore, particularly when communication through carrier aggregation is performed, bundling is applied to response signal transmission control over initial transmission data, while non-bundling is applied to response signal transmission control over retransmission data.

Descriptions will be given below assuming the following matters as premises. That is, symmetric carrier aggregation peculiar to terminal 200 is configured beforehand between base station 100 and terminal 200 and information of the downlink unit band and uplink unit band to be used by terminal 200 is shared between base station 100 and terminal 200.

[Configuration of Base Station]

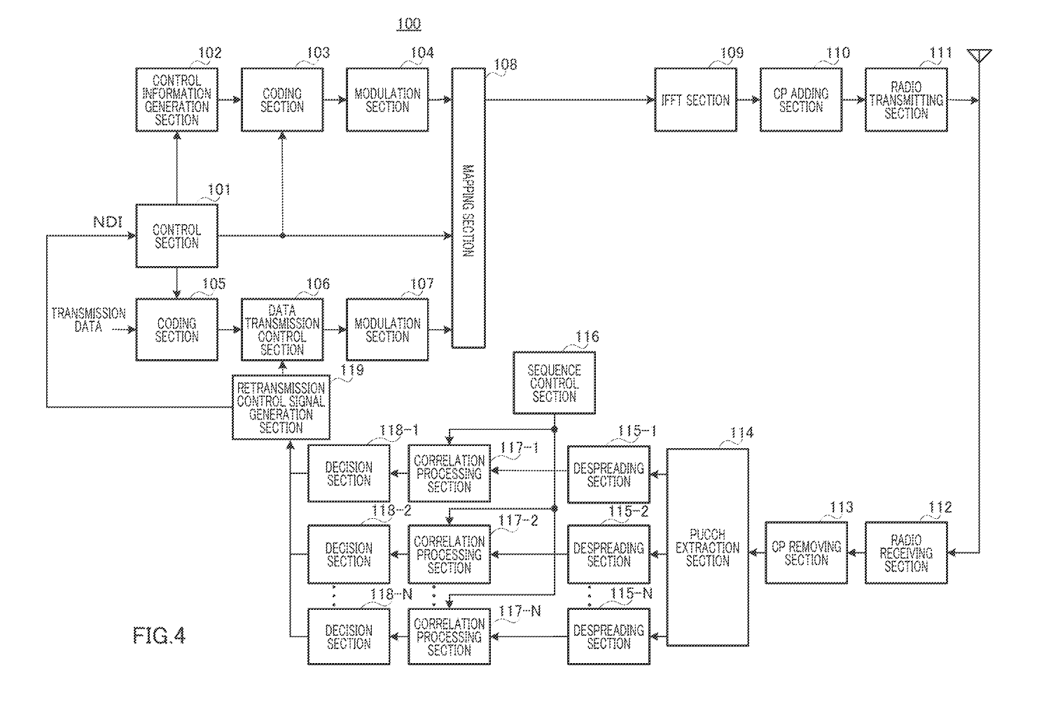

FIG. 4 is a block diagram showing a configuration of base station 100 according to Embodiment 1 of the present invention. In FIG. 4, base station 100 includes control section 101, control information generation section 102, coding section 103, modulation section 104, coding section 105, data transmission control section 106, modulation section 107, mapping section 108, IFFT section 109, CP adding section 110, radio transmitting section 111, radio receiving section 112, CP removing section 113, PUCCH extraction section 114, despreading section 115, sequence control section 116, correlation processing section 117, decision section 118 and retransmission control signal generation section 119.

Control section 101 assigns downlink resources for transmitting control information (that is, downlink control information assignment resources) and downlink resources for transmitting downlink data (that is, downlink data assignment resources) included in the control information to resource assignment target terminal 200. This resource assignment is performed in the downlink unit band included in a unit band group set (configured) in resource assignment target terminal 200. Furthermore, downlink control information assignment resources are selected from among resources corresponding to a downlink control channel (PDCCH) in each downlink unit band. Furthermore, downlink data assignment resources are selected from among resources corresponding to a downlink data channel (PDSCH) in each downlink unit band. Furthermore, when there are a plurality of resource assignment target terminals 200, control section 101 assigns different resources to respective resource assignment target terminals 200.

For initial transmission data to resource assignment target terminal 200, control section 101 sets a unit band group variable in short-term made up of one or more downlink unit bands and uplink unit bands included in the unit band group for resource assignment target terminal 200. Since the number of downlink unit bands may be different from the number of uplink unit bands (to be more specific, the number of uplink unit bands may be smaller than the number of downlink unit bands), the short-term variable unit band group may be asymmetric between the uplink and downlink. Furthermore, the setting of this short-term variable unit band group can be changed, for example, in subframe units. Furthermore, an uplink unit band included in the short-term variable unit band group forms a “unit band pair” with one of the downlink unit bands that belong to the same short-term variable unit band group. Furthermore, for retransmission data to resource assignment target terminal 200, control section 101 sets a unit band pair (pair of an uplink unit band and a downlink unit band) in the unit band group for resource assignment target terminal 200. The setting of this unit band pair to transmit the retransmission data can be changed for each subframe.

The downlink control information assignment resource is equivalent to the above described L1/L2 CCH. That is, the downlink control information assignment resource is made up of one or a plurality of CCEs. Furthermore, each CCE is associated with a component resource of an uplink control channel (PUCCH) on a one-by-one basis. However, the association between CCEs and PUCCH component resources are established through association between a downlink unit band and an uplink unit band broadcast to an LTE system. That is, all component resources of a PUCCH associated with CCEs making up a plurality of downlink control information assignment resources transmitted to terminal 200 are not necessarily included in the uplink unit band group set for terminal 200.

Furthermore, control section 101 determines a coding rate used to transmit control information to resource assignment target terminal 200. Since the amount of data of the control information differs according to this coding rate, control section 101 assigns downlink control information assignment resources having a number of CCEs capable of mapping control information of this amount of data.

Furthermore, control section 101 receives an NDI from retransmission control signal generation section 119. This NDI is information indicating whether downlink data transmitted in each downlink unit band is initial transmission data or retransmission data.

Control section 101 then outputs information on the downlink data assignment resources as well as the NDI to control information generation section 102. Furthermore, control section 101 outputs information on a coding rate to coding section 103. Control section 101 determines a coding rate of transmission data (that is, downlink data) and outputs the coding rate to coding section 106. Furthermore, control section 101 outputs information on downlink data assignment resources and downlink control information assignment resources to mapping section 108. However, control section 101 performs control such that the downlink data and downlink control information corresponding to the downlink data are mapped to the same downlink unit band.

Control information generation section 102 generates control information including the downlink data assignment resources and the NDI and outputs the control information to coding section 103. This control information is generated for each downlink unit band. Furthermore, when there are a plurality of resource assignment target terminals 200, the control information includes a terminal ID of the destination terminal to distinguish between resource assignment target terminals 200. For example, a CRC bit masked with a terminal ID of the destination terminal is included in the control information. This control information may be called “downlink assignment control information.”

Furthermore, control information generation section 102 outputs information on the downlink control information assignment resources to mapping section 108 via coding section 103 and modulation section 104. This causes mapping section 108 to map the control information to downlink control information assignment resources.

Coding section 103 encodes the control information according to the coding rate received from control section 101 and outputs the coded control information to modulation section 104.

Modulation section 104 modulates the coded control information and outputs the modulated signal obtained to mapping section 108.

Coding section 105 receives transmission data per destination terminal 200 (that is, downlink data) and coding rate information from control section 101 as input and encodes the transmission data at the coding rate indicated by the coding rate information and outputs the coded transmission data to data transmission control section 106. However, when a plurality of downlink unit bands are assigned to destination terminal 200, coding section 105 encodes transmission data transmitted in each downlink unit band and outputs the coded transmission data to data transmission control section 106.

At the time of initial transmission, data transmission control section 106 stores the coded transmission data and also outputs the coded transmission data to modulation section 107. The coded transmission data is stored for each destination terminal 200. Furthermore, transmission data for one destination terminal 200 is stored for each downlink unit band transmitted. This enables not only retransmission control over whole data transmitted to destination terminal 200 but also retransmission control per downlink unit band.

Furthermore, when the retransmission control signal received from retransmission control signal generation section 119 indicates a retransmission command, data transmission control section 106 outputs the stored data corresponding to the retransmission control signal to modulation section 107. Furthermore, when the retransmission control signal received from retransmission control signal generation section 119 indicates that the data is not to be retransmitted, data transmission control section 106 deletes the stored data corresponding to the retransmission control signal. In this case, data transmission control section 106 outputs the next initial transmission data to modulation section 107. With regard to the initial transmission data, since a bundled ACK/NACK signal relating to a plurality of pieces of initial transmission data is transmitted from terminal 200, upon receiving a retransmission control signal indicating a retransmission command, data transmission control section 106 outputs all of the plurality of pieces of stored data involving the bundled ACK/NACK signal to modulation section 107. Furthermore, since non-bundling is applied to a response signal of the retransmission data here, upon receiving the retransmission control signal for further retransmitting retransmission data, data transmission control section 106 outputs one piece of the stored data corresponding to the retransmission control signal to modulation section 107.

Modulation section 107 modulates the coded transmission data received from data transmission control section 106 and outputs the modulated signal to mapping section 108.

Mapping section 108 maps the modulated signal of the control information received from modulation section 104 to resources indicated by the downlink control information assignment resources received from control section 101 and outputs the mapping result to IFFT section 109.

Furthermore, mapping section 108 maps the modulated signal of the transmission data received from modulation section 107 to resources indicated by the downlink data assignment resources received from control section 101 and outputs the mapping result to IFFT section 109.

According to the above described configuration, the control information and initial transmission data directed to resource assignment target terminal 200 are mapped to a downlink unit band making up the short-term variable unit band group and the control information and retransmission data directed to resource assignment target terminal 200 are mapped to the downlink unit band to be retransmitted.

The control information and transmission data mapped to a plurality of subcarriers in a plurality of downlink unit bands by mapping section 109 are transformed by IFFT section 110 from a frequency domain signal to a time domain signal, transformed into an OFDM signal with a CP added by CP adding section 110, subjected to transmission processing such as D/A conversion, amplification and up-conversion in radio transmitting section 111 and transmitted to terminal 200 via an antenna.

Radio receiving section 112 receives a response signal or reference signal transmitted from terminal 200 via the antenna, and performs reception processing such as down-conversion, A/D conversion on the response signal or reference signal.

CP removing section 113 removes a CP added to the response signal or reference signal after the reception processing.

PUCCH extraction section 114 extracts an uplink control channel signal included in the received signal for each uplink unit band and divides the extracted uplink control channel (PUCCH) signals among uplink unit bands. This uplink control channel signal may include the response signal and reference signal transmitted from terminal 200.

Despreading section 115-N, correlation processing section 117-N and decision section 118-N perform processing on the uplink control channel signal extracted in uplink unit band N. Base station 100 is provided with a processing system of spreading section 115, correlation processing section 117 and decision section 118 corresponding to uplink unit bands 1 to N available to base station 100.

To be more specific, despreading section 115 despreads the response signal in a block-wise spreading code sequence used for secondary spreading used by terminal 200 in the respective uplink unit bands and outputs the despread response signal to correlation processing section 117. Furthermore, despreading section 115 despreads the reference signal in the orthogonal sequence used to spread the reference signal used by terminal 200 in respective uplink unit bands and outputs the despread reference signal to correlation processing section 117.

Sequence control section 116 generates a ZAC sequence used to spread the response signal transmitted from terminal 200. Furthermore, sequence control section 116 identifies a correlation window containing a signal component from terminal 200 in uplink unit bands 1 to N respectively based on code resources (e.g. amount of cyclic shift) used in terminal 200. Sequence control section 116 then outputs information indicating the identified correlation window and the ZAC sequence generated to correlation processing section 117.

Correlation processing section 117 obtains a correlation value between the despread response signal and despread reference signal, and the ZAC sequence used for primary spreading in terminal 200 using the information indicating the correlation window and the ZAC sequence inputted from sequence control section 116 and outputs the correlation value to decision section 118.

Decision section 118 decides whether the response signal transmitted from the terminal indicates ACK or NACK or DTX based on the correlation value inputted from correlation processing section 117. That is, when the magnitude of the correlation value inputted from correlation processing section 117 is a certain threshold or below, decision section 118 decides that terminal 200 transmits neither ACK nor NACK (DTX) using the resources and when the magnitude of the correlation value is the threshold or above, decision section 118 further decides whether the response signal indicates ACK or NACK through coherent detection. Decision section 118 outputs ACK, NACK or DTX information per terminal to retransmission control signal generation section 119.

Retransmission control signal generation section 119 decides whether data transmitted in each downlink unit band should be retransmitted or not based on a plurality of response signals included in the received signal and generates a retransmission control signal based on the decision result.

That is, retransmission control signal generation section 119 receives a bundled ACK/NACK signal or DTX from decision section 118 corresponding to the uplink unit band in which the bundled ACK/NACK signal in the short-term variable unit band group is transmitted. On the other hand, retransmission control signal generation section 119 receives a response signal or DTX relating to the retransmission data from decision section 118 corresponding to the uplink unit band in which the response signal relating to the retransmission data is transmitted.

Retransmission control signal generation section 119 controls retransmission of the transmission data whose previous transmission was initial transmission based on the bundled ACK/NACK signal or DTX and also controls retransmission of the transmission data whose previous transmission was also retransmission based on the response signal or DTX relating to the retransmission data.

To be more specific, when receiving a bundled ACK/NACK signal indicating NACK or DTX, retransmission control signal generation section 119 generates a retransmission control signal indicating a retransmission command and outputs the retransmission control signal to data transmission control section 106 and also outputs an NDI indicating retransmission (that is, NDI bit=0) to control section 101. Furthermore, when receiving a bundled ACK/NACK signal indicating ACK, retransmission control signal generation section 119 generates a retransmission control signal indicating that retransmission will not be performed, outputs the retransmission control signal to data transmission control section 106 and also outputs an NDI indicating initial transmission (that is, NDI bit=1) to control section 101.

Furthermore, when receiving NACK or DTX as a response signal relating to retransmission data, retransmission control signal generation section 119 generates a retransmission control signal indicating a retransmission command and outputs the retransmission control signal to data transmission control section 106 and also outputs an NDI indicating retransmission to control section 101. Furthermore, when receiving ACK as a response signal relating to retransmission data, retransmission control signal generation section 119 generates a retransmission control signal indicting that retransmission will not be performed and outputs the retransmission control signal to data transmission control section 106.

[Configuration of Terminal]

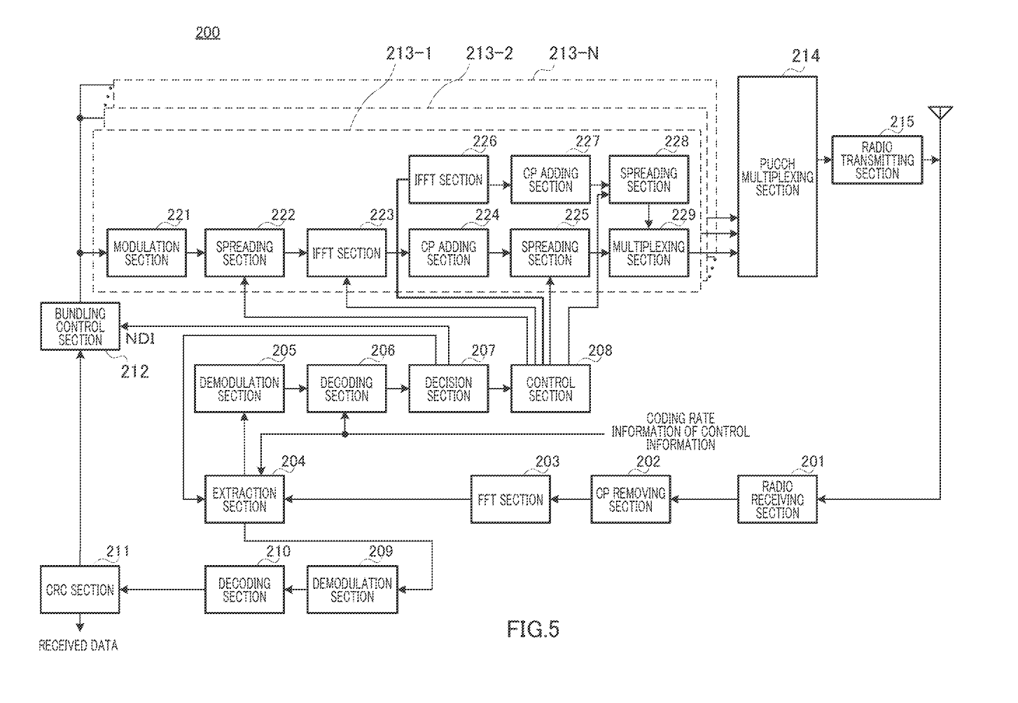

FIG. 5 is a block diagram showing a configuration of terminal 200 according to Embodiment 1 of the present invention. In FIG. 5, terminal 200 includes radio receiving section 201, CP removing section 202, FFT section 203, extraction section 204, demodulation section 205, decoding section 206, decision section 207, control section 208, demodulation section 209, decoding section 210, CRC section 211, bundling control section 212, uplink control channel signal generation sections 213-1 to N, PUCCH multiplexing section 214 and radio transmitting section 215.

Radio receiving section 201 receives an OFDM signal transmitted from base station 100 via an antenna and performs reception processing such as down-conversion, A/D conversion on the received OFDM signal.

CP removing section 202 removes a CP added to the OFDM signal after the reception processing.

FFT section 203 applies FFT to the received OFDM signal to transform it to a frequency domain signal and outputs the received signal obtained to extraction section 204.

Extraction section 204 extracts a downlink control channel signal (PDCCH signal) from the received signal received from FFT section 203 according to inputted coding rate information. That is, since the number of CCEs making up a downlink control information assignment resource changes depending on the coding rate, extraction section 204 extracts the downlink control channel signal using a number of CCEs corresponding to the coding rate as an extraction unit. Furthermore, the downlink control channel signal is extracted for each downlink unit band. The extracted downlink control channel signal is outputted to demodulation section 205.

Furthermore, extraction section 204 extracts downlink data from the received signal based on information on downlink data assignment resources directed to the terminal received from decision section 207 and outputs the downlink data to demodulation section 209.

Demodulation section 205 demodulates the downlink control channel signal received from extraction section 204 and outputs the demodulation result obtained to decoding section 206.

Decoding section 206 decodes the demodulation result received from demodulation section 205 according to coding rate information inputted and outputs the decoding result obtained to decision section 207.

Decision section 207 makes a blind detection as to whether control information included in the decoding result received from decoding section 206 is control information directed to the terminal or not. This decision is made based on the unit of the decoding result corresponding to the above described extraction unit. For example, decision section 207 demasks a CRC bit with a terminal ID of the terminal and decides control information resulting in CRC=OK (no error) to be control information directed to the terminal. Decision section 207 then outputs information on the downlink data assignment resources for the terminal included in control information directed to the terminal to extraction section 204. Furthermore, decision section 207 extracts an NDI indicating whether the downlink data directed to the terminal is initial transmission data or retransmission data from the control information of each downlink unit band and outputs the NDI to bundling control section 212.

Furthermore, decision section 207 identifies the downlink unit band to which the control information directed to the terminal is mapped and a CCE to which the control information directed to the terminal is mapped in the downlink unit band and outputs the identified downlink unit band and the identification information of the CCE to control section 208.

Control section 208 identifies an uplink unit band which forms a pair with the downlink unit band indicated by the identification information of the downlink unit band received from decision section 207 and a PUCCH resource (frequency and code) corresponding to the CCE indicated by the CCE identification information. Control section 208 then outputs the ZAC sequence and the amount of cyclic shift corresponding to the PUCCH resources identified in the uplink unit band that forms a pair with each downlink unit band to spreading section 222 of uplink control channel signal generation sections 213-1 to N corresponding to each uplink unit band and outputs the frequency resource information to IFFT section 223. Furthermore, control section 208 outputs the ZAC sequence and frequency resource information as a reference signal to IFFT section 226, outputs a block-wise spreading code sequence to be used for secondary spreading of the response signal to spreading section 225 and outputs an orthogonal sequence to be used for secondary spreading of the reference signal to spreading section 228.

Demodulation section 209 demodulates the downlink data received from extraction section 204 and outputs the demodulated downlink data to decoding section 210.

Decoding section 210 decodes the downlink data received from demodulation section 209 and outputs the decoded downlink data to CRC section 211.

CRC section 211 generates decoded downlink data received from decoding section 210, performs error detection per downlink unit band using a CRC and outputs ACK when CRC=OK (no error) or NACK when CRC=NG (error present) to bundling control section 212. Furthermore, when CRC=OK (no error), CRC section 211 outputs the decoded downlink data as received data.

Bundling control section 212 generates a response signal to be transmitted from the terminal to base station 100 based on the reception condition of the downlink data transmitted in each downlink unit band included in the unit band group set in the terminal and the NDI received from decision section 207.

To be more specific, bundling control section 212 generates a bundled ACK/NACK signal as a response signal based on success/failure in receiving downlink data (that is, initial transmission data) received in the downlink unit band of the short-term variable unit band group set in the terminal. To be more specific, when a plurality of pieces of downlink data (that is, initial transmission data) are included in the short-term variable unit band group, a bundled ACK/NACK signal is generated by calculating logical AND of a response signal for a plurality of pieces of downlink data, and when only one piece of downlink data (that is, initial transmission data) is included in the short-term variable unit band group, a response signal for the downlink data is used as a bundled ACK/NACK signal. Bundling control section 212 outputs this bundled ACK/NACK signal to uplink control channel signal generation section 213 corresponding to one uplink unit band of the short-term variable unit band group.

Furthermore, bundling control section 212 generates a response signal based on success/failure in receiving downlink data (that is, retransmission data) received in the downlink unit band of the remaining unit band after excluding the component unit band of the short-term variable unit band group from the component unit band of the unit band group set in the terminal. Bundling control section 212 outputs this response signal to uplink control channel signal generation section 213 corresponding to the uplink unit band that forms a band pair with the downlink unit band in which the retransmission data is received.

Uplink control channel signal generation section 213 generates an uplink control channel signal to be transmitted in the uplink unit band based on the response signal received from bundling control section 212. Terminal 200 is provided with uplink control channel signal generation sections 213-1 to N corresponding to uplink unit bands 1 to N available to base station 100 and terminal 200.

To be more specific, uplink control channel signal generation section 213 includes modulation section 221, spreading section 222, IFFT section 223, CP adding section 224, spreading section 225, IFFT section 226, CP adding section 227, spreading section 228 and multiplexing section 229.

Modulation section 221 modulates the response signal inputted from bundling control section 212 and outputs the modulated response signal to spreading section 222.

Spreading section 222 primary-spreads the response signal based on the ZAC sequence and the amount of cyclic shift set by control section 208 and outputs the primary-spread response signal to IFFT section 223. That is, spreading section 222 primary-spreads the response signal according to the command from control section 208.

IFFT section 223 arranges the primary-spread response signal on the frequency axis based on the frequency resource information inputted from control section 208 and performs IFFT. IFFT section 223 then outputs the response signal after the IFFT to CP adding section 224.

CP adding section 224 adds the same signal as the end portion of the response signal after the IFFT at the head of the response signal as a CP.

Spreading section 225 secondary-spreads the response signal with the CP added using a block-wise spreading code sequence set by control section 208 and outputs the secondary-spread response signal to multiplexing section 229. That is, spreading section 225 secondary-spreads the primary-spread response signal using the block-wise spreading code sequence corresponding to the resource selected by control section 208.

IFFT section 226 arranges the reference signal on the frequency axis based on the frequency resource information inputted from control section 208 and performs IFFT. IFFT section 226 outputs the reference signal after the IFFT to CP adding section 227.

CP adding section 227 adds the same signal as the end portion of the reference signal after the IFFT at the head of the reference signal as a CP.

Spreading section 228 spreads the reference signal with the CP added in the orthogonal sequence commanded from control section 208 and outputs the spread reference signal to multiplexing section 229.

Multiplexing section 229 time-multiplexes the secondary-spread response signal and the spread reference signal in one slot and outputs the multiplexed signal to PUCCH multiplexing section 214.

PUCCH multiplexing section 214 superimposes a plurality of uplink control channel signals inputted from uplink control channel signal generation sections 213-1 to N one on another on the frequency axis and outputs the multiplexed signal obtained to radio transmitting section 215.

Radio transmitting section 215 performs transmission processing such as D/A conversion, amplification and up-conversion on the multiplexed signal received from PUCCH multiplexing section 214 and transmits the multiplexed signal to base station 100 from an antenna.

[Operations of Base Station 100 and Terminal 200]

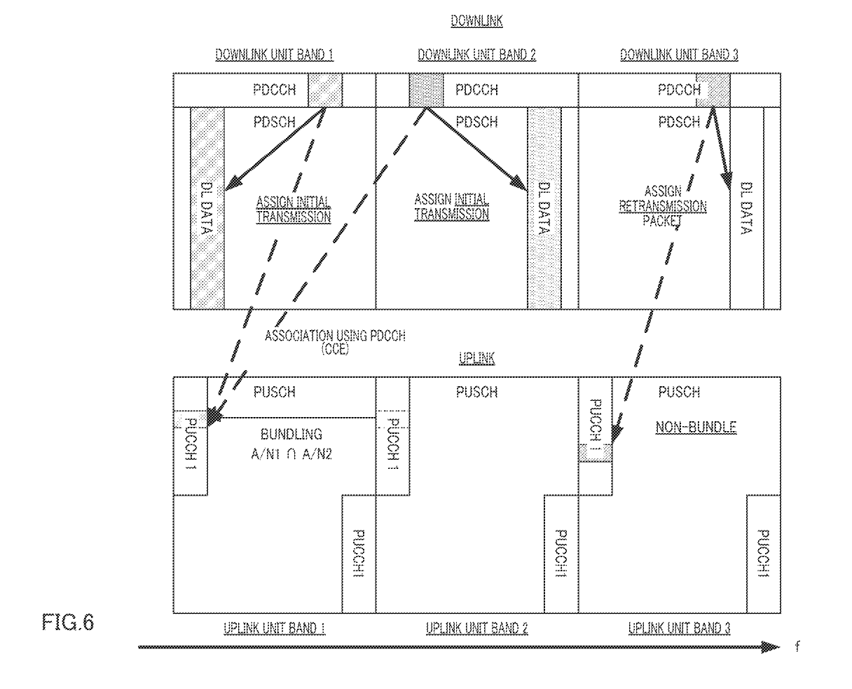

Operations of base station 100 and terminal 200 in the above described configurations will be described. FIG. 6 is a diagram illustrating operations of base station 100 and terminal 200.

<Resource Assignment Control and Transmission of Downlink Assignment Control Information and Downlink Data by Base Station 100>

In base station 100, control section 101 stores information on the base unit band in the unit band group set in each terminal 200. Control section 101 sets a short-term variable unit band group made up of downlink unit bands and uplink unit bands included in the unit band group in resource assignment target terminal 200 for initial transmission data to resource assignment target terminal 200. Since the number of downlink unit bands may be different from the number of uplink unit bands (to be more specific, the number of uplink unit bands may be smaller than the number of downlink unit bands), this short-term variable unit band group may be asymmetric between the uplink and the downlink. Furthermore, the setting of the short-term variable unit band group may be changed, for example, in subframe units. Furthermore, the uplink unit band included in the short-term variable unit band group forms a “unit band pair” with one of the downlink unit bands that belong to the same short-term variable unit band group. Furthermore, control section 101 sets a unit band pair (pair of the uplink unit band and the downlink unit band) in the unit band group for resource assignment target terminal 200 for the retransmission data to resource assignment target terminal 200. The setting of the unit band pair for transmitting this retransmission data can be changed for each subframe.

Base station 100 transmits downlink assignment control information in the short-term variable unit band group and the downlink unit band group of the unit band pair set in destination terminal 200 to downlink data destination terminal 200.

This will be described more specifically with reference to FIG. 6. FIG. 6 shows a condition of a downlink control channel and downlink data channel in each downlink unit band and an uplink control channel in each uplink unit band of a unit band group in a certain subframe. In the condition shown in FIG. 6, a symmetric unit band group made up of downlink unit bands 1, 2 and 3, and uplink unit bands 1, 2 and 3 is set for downlink data destination terminal 200. Furthermore, in the subframe whose condition is shown in FIG. 6, a short-term variable unit band group made up of downlink unit bands 1, 2 and uplink unit band 1 is set and a band pair of downlink unit band 3 and uplink unit band 3 is set to transmit retransmission data to destination terminal 200. Base station 100 transmits downlink assignment control information in each of the short-term variable unit band group and the downlink unit band group of the unit band pair (that is, downlink unit bands 1, 2 and 3) set in destination terminal 200.

Base station 100 then transmits initial transmission data through downlink data channels of the downlink unit bands making up the short-term variable unit band group (that is, downlink unit bands 1 and 2). Furthermore, base station 100 transmits retransmission data through a downlink data channel of the downlink unit band making up the unit band pair (that is, downlink unit band 3).

<Response by Terminal 200>

In terminal 200, CRC section 211 performs error detection for downlink data corresponding to downlink assignment control information which has been received successfully and outputs the error detection result to bundling control section 212.

Bundling control section 212 decides whether the downlink data in a plurality of downlink unit bands received by terminal 200 is initial transmission data or retransmission data based on an NDI received from decision section 207.

Bundling control section 212 then generates a bundled ACK/NACK signal based on an error detection result on the initial transmission data transmitted in a downlink unit band of a short-term variable unit band group. That is, the short-term variable unit band group is a “bundling unit band group” in which a response signal is generated through bundling. To be more specific, when the short-term variable unit band group includes a plurality of pieces of initial transmission data, bundling control section 212 generates only one “ACK” as the bundled ACK/NACK signal when all error detection results show CRC=OK for initial transmission data and outputs the ACK to uplink control channel signal generation section 213 corresponding to the uplink unit band of the short-term variable unit band group. On the other hand, when even one error detection result shows CRC=NG of the plurality of pieces of initial transmission data, bundling control section 212 generates only one “NACK” as the bundled ACK/NACK signal and outputs the NACK to uplink control channel signal generation section 213 corresponding to the uplink unit band of the short-term variable unit band group. However, when the short-term variable unit band group includes only one piece of initial transmission data and the error detection result of the initial transmission data is CRC=OK, bundling control section 212 generates “ACK” as the bundled ACK/NACK signal, whereas when the short-term variable unit band group includes only one piece of initial transmission data and the error detection result of the initial transmission data is CRC=NG, bundling control section 212 generates “NACK” as the bundled ACK/NACK signal and outputs the NACK to uplink control channel signal generation section 213 corresponding to the uplink unit band of the short-term variable unit band group.

Bundling control section 212 generates a response signal based on the error detection result of the retransmission data transmitted in the downlink unit band of the unit band pair. That is, a response signal for the retransmission data is generated independently without being bundled with the response signal for the initial transmission data. To be more specific, bundling control section 212 generates ACK when the error detection result about the retransmission data shows CRC=OK and outputs the ACK to uplink control channel signal generation section 213 corresponding to the uplink unit band of the unit band pair. On the other hand, when the error detection result about the retransmission data shows CRC=NG, bundling control section 212 generates NACK and outputs the NACK to uplink control channel signal generation section 213 corresponding to the uplink unit band of the unit band pair.

Control section 208 identifies an uplink unit band that forms a pair with the downlink unit band indicated by identification information of the downlink unit band received from decision section 207 and PUCCH resources (frequency and code) corresponding to a CCE indicated by the CCE identification information. Control section 208 then outputs the ZAC sequence and amount of cyclic shift corresponding to the PUCCH resources identified in the uplink unit band that forms a pair with each downlink unit band to spreading section 222 of uplink control channel signal generation sections 213-1 to N corresponding to each uplink unit band and outputs frequency resource information to IFFT section 223. Furthermore, control section 208 outputs the ZAC sequence and frequency resource information as a reference signal to IFFT section 226, outputs a block-wise spreading code sequence to be used for secondary spreading of a response signal to spreading section 225 and outputs an orthogonal sequence to be used for secondary spreading of the reference signal to spreading section 228.

This will be described more specifically with reference to FIG. 6. Bundling control section 212 generates a bundled ACK/NACK signal based on an error detection result on initial transmission data transmitted in a downlink unit band (that is, downlink unit bands 1 and 2 here) of a short-term variable unit band group. Bundling control section 212 then outputs the bundled ACK/NACK signal generated to uplink control channel signal generation section 213 corresponding to the uplink unit band (that is, uplink unit band 1) of the short-term variable unit band group. Uplink control channel signal generation section 213 then transmits an uplink control channel signal including the bundled ACK/NACK signal using resources set by control section 208. These resources are component resources of the uplink control channel of uplink unit band 1 associated with the CCE of the downlink control channel of downlink unit band 1.

Here, uplink unit band 2 that forms a unit band pair with downlink unit band 2 can also be selected as an uplink unit band of the short-term variable unit band group including downlink unit bands 1 and 2. In this case, bundling control section 212 outputs the bundled ACK/NACK signal to uplink control channel signal generation section 213 corresponding to uplink unit band 2. However, in FIG. 6, of the uplink unit band group (that is, uplink unit bands 1 and 2) which forms a unit band pair with a plurality of downlink unit bands (that is, downlink unit bands 1 and 2) making up the short-term variable unit band group, for example, an uplink unit band selected using an uplink unit band of the lowest frequency as a selection criterion (that is, uplink unit band 1) is included in the short-term variable unit band.

<Retransmission Control by Base Station 100>

In base station 100, retransmission control signal generation section 119 decides whether or not to retransmit data transmitted in each downlink unit band based on a plurality of response signals included in the received signal and generates a retransmission control signal based on the decision result. That is, retransmission control signal generation section 119 controls retransmission of transmission data whose previous transmission was initial transmission based on a bundled ACK/NACK signal and also controls retransmission of transmission data whose previous transmission was also retransmission based on a response signal relating to retransmission data.

To be more specific, when ACK is received as the bundled ACK/NACK signal, retransmission control signal generation section 119 decides that initial transmission data has reached terminal 200 without problems and generates a retransmission control signal so as not to perform retransmission of all initial transmission data (that is, initial transmission data transmitted in the same subframe) whose success/failure in reception is indicated by this bundled ACK/NACK signal. On the other hand, when NACK is received as the bundled ACK/NACK signal, retransmission control signal generation section 119 generates a retransmission control signal so as to command retransmission control over all initial transmission data, the bundled ACK/NACK signal indicating success/failure in receiving the initial transmission data.

Furthermore, retransmission control signal generation section 119 individually controls a response signal for retransmission data. That is, retransmission control signal generation section 119 checks whether the response signal from terminal 200 is ACK or NACK, and generates a control signal as to whether or not to retransmit the retransmission data on the next opportunity.

Through the above described control, it is possible to separate transmission control over a response signal relating to initial transmission data having a high packet error rate from transmission control over a response signal relating to retransmission data having a low packet error rate without increasing signaling overhead and also suppress to a minimum the amount of uplink control channel resources used while reducing deterioration of retransmission efficiency due to bundling (bundling effect). That is, the system throughput can be improved.

As described above, according to the present embodiment, base station 100 communicates with terminal 200 using a unit band group made up of N downlink unit bands and an uplink unit band.

In base station 100, control section 101 sets a bundling unit band group including the first and second downlink unit bands of the N downlink unit bands and mapping section 108 maps initial transmission data of the downlink data to the first and second downlink unit bands of the bundling unit band group and also maps retransmission data to the third downlink unit band except the downlink unit band of the bundling unit band group out of the N downlink unit bands.

Furthermore, terminal 200 communicates with base station 100 using the unit band group made up of the N downlink unit bands and the uplink unit band and transmits a response signal based on the downlink data error detection result arranged in the downlink unit band through an uplink control channel of the uplink unit band corresponding to the downlink unit band.

In terminal 200, extraction section 204, demodulation section 205 and decoding section 206 as a control information receiving section receive the downlink assignment control information transmitted through downlink control channels of a plurality of downlink unit bands and extraction section 204, demodulation section 209 and decoding section 210 as a downlink data receiving section receive downlink data transmitted through a downlink data channel indicated by the downlink assignment control information. Furthermore, CRC section 211 detects a reception error of downlink data, decision section 207 decides whether downlink data received in each downlink unit band is initial transmission data or retransmission data, and bundling control section 212 controls transmission of a response signal used for retransmission control over downlink data in base station 100 based on the error detection result obtained in CRC section 211, success/failure in reception of downlink assignment control information and the decision result in decision section 207.

Bundling control section 212 then transmits a response signal for initial transmission data using component resources of the uplink control channel, the component resources being associated with the downlink control channel of the downlink unit band in which initial transmission data is transmitted, and the component resources being provided in the uplink unit band, and transmits a response signal for retransmission data using resources different from resources of the response signal for the initial transmission data. In Embodiment 1, bundling control section 212 especially transmits a response signal for retransmission data using component resources of the uplink control channel associated with the downlink control channel of the downlink unit band in which retransmission data is transmitted and provided in the other uplink unit band.

By so doing, it is possible to separate control over initial transmission data from retransmission control over retransmission data without increasing signaling overhead and thereby realize retransmission control with high flexibility while preventing overhead of the uplink control channel from increasing.

A case has been described above where a short-term variable unit band is set, for example, in subframe units. However, the present invention is not limited to this, but the short-term variable unit band may be fixed for a relatively long period in the same way as for the unit band group. That is, an asymmetric unit band group may be used which includes a plurality of uplink unit bands and has more downlink unit bands than uplink unit bands. In the example shown in FIG. 6, downlink unit bands 1, 2 and 3, and uplink unit bands 1 and 3 make up a unit band group. In short, it is only necessary to separate retransmission control over initial transmission data from retransmission control over retransmission data.

A case has been described above where a ZAC sequence is used for primary spreading and a block-wise spreading code sequence is used for secondary spreading. However, sequences other than ZAC sequences, which are separable from each other by different amounts of cyclic shift may also be used for primary spreading. For example, a GCL (Generalized Chirp like) sequence, CAZAC (Constant Amplitude Zero Auto Correlation) sequence, ZC (Zadoff-Chu) sequence, PN sequence such as M sequence and orthogonal gold code sequence or a sequence having abrupt auto-correlation characteristics on the time axis randomly generated by a computer may also be used for primary spreading. On the other hand, for secondary spreading, any sequences may be used as block-wise spreading code sequences as long as these sequences are orthogonal to each other or sequences that can be regarded as being substantially orthogonal to each other. For example, a Walsh sequence or Fourier sequence or the like may be used as a block-wise spreading code sequence for secondary-spreading. In the above descriptions, resources for a response signal (e.g. PUCCH resources) are defined by the amount of cyclic shift of a ZAC sequence and a sequence number of the block-wise spreading code sequence.

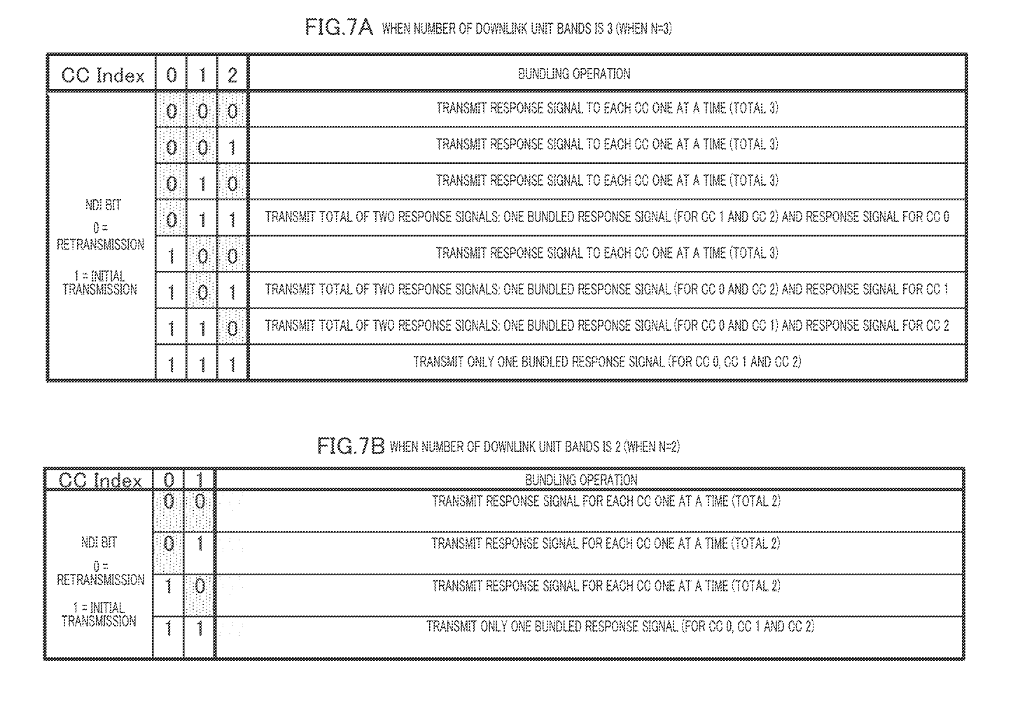

FIG. 7 shows a relationship between a type of data transmitted in a downlink unit band (that is, initial transmission data or retransmission data) and a type of response signal (that is, response signal using bundling or response signal using non-bundling). FIG. 7A shows a case where there are three downlink unit bands and FIG. 7B shows a case where there are two downlink unit bands. A case has been particularly described in FIG. 6 as an example where initial transmission data is transmitted in two downlink unit bands and retransmission data is transmitted in one downlink unit band, which is different from that for the initial transmission data (in FIG. 7A, the fourth, sixth and seventh cases). However, Embodiment 1 is not limited to a case where three are three downlink unit bands, but Embodiment 1 is also applicable to a case where there are two downlink unit bands. That is, as shown in FIG. 7B, similar effects can be maintained by bundling only response signals for data whose NDI bit is 1 (initial transmission data) and non-bundling (transmitting separately) response signals for data having different NDI bits or data whose NDI bit is 0. In this case, unlike the case shown in FIG. 6, a subframe in which initial transmission data is arranged in two downlink unit bands and a bundled ACK/NACK signal is transmitted as a response signal is temporally shifted (that is, time-shared) from a subframe in which retransmission data is arranged in at least one downlink unit band.

### Embodiment 2

In Embodiment 1, communication is performed through symmetric carrier aggregation peculiar to terminal 200. Furthermore, in Embodiment 1, a response signal using bundling and a response signal using non-bundling are transmitted in different uplink unit bands. By contrast, in Embodiment 2, communication is performed through asymmetric carrier aggregation peculiar to each terminal. Furthermore, Embodiment 2 is common to Embodiment 1 in that a response signal using bundling and a response signal using non-bundling are transmitted through different uplink resources, but in Embodiment 2, a response signal using bundling and a response signal using non-bundling are transmitted through an uplink control channel of the same uplink unit band. However, the response signal using bundling and the response signal using non-bundling are arranged in different resources of the same uplink control channel. Moreover, in Embodiment 2, transmission is performed by including a DAI (Downlink Assignment Indicator) which is information indicating the number of downlink unit bands to which resources are assigned to one resource assignment target terminal for initial transmission data in downlink assignment control information. That is, the DAI indicates the number of downlink unit bands included in a bundling unit band.

[Overview of Communication System]

A communication system including base station 300 and terminal 400, which will be described later, performs communication using an uplink unit band and a plurality of downlink unit bands associated with the uplink unit band, that is, communication through asymmetric carrier aggregation peculiar to terminal 400. Furthermore, this communication system also includes a terminal that has no capability to perform communication through carrier aggregation unlike terminal 400 and performs communication through one downlink unit band and one uplink unit band associated therewith (that is, communication without carrier aggregation).

Therefore, base station 300 is configured to be able to support both communication through asymmetric carrier aggregation and communication without carrier aggregation.

Furthermore, is also possible to perform communication without carrier aggregation between base station 300 and terminal 400 depending on resource assignment to terminal 400 by base station 100.

Descriptions will be given below assuming the following matters as premises. That is, asymmetric carrier aggregation peculiar to terminal 400 is constructed beforehand between base station 300 and terminal 400 and information of the downlink unit band and uplink unit band to be used by terminal 400 is shared between base station 300 and terminal 400.

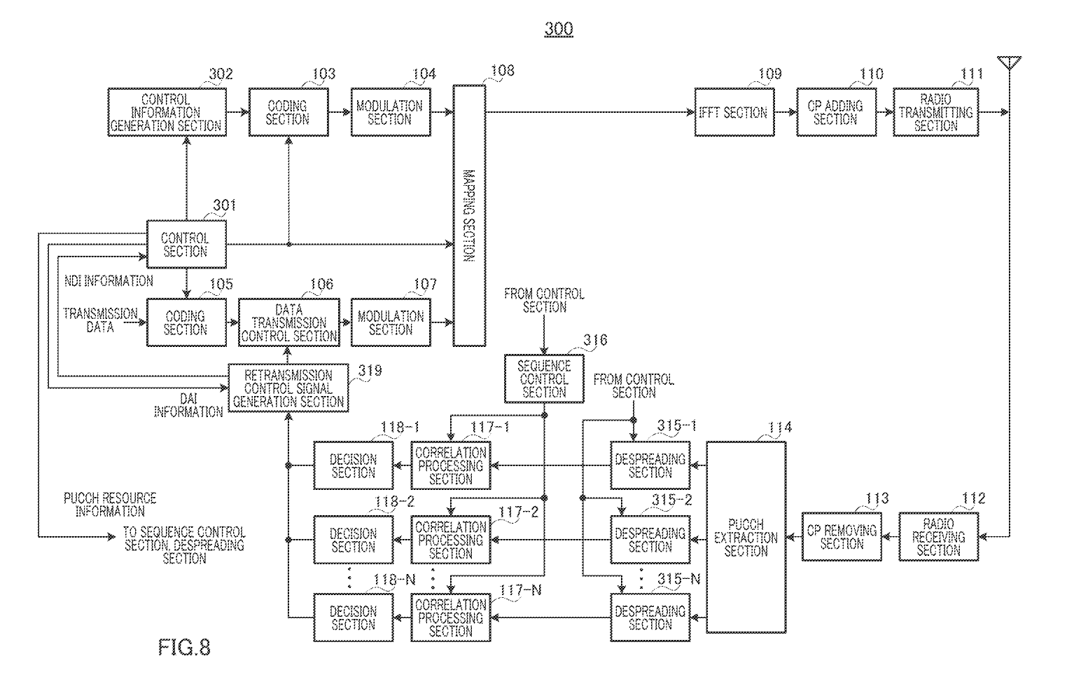

FIG. 8 is a block diagram showing a configuration of base station 300 according to Embodiment 2 of the present invention. In FIG. 8, base station 300 includes control section 301, control information generation section 302, despreading section 315, sequence control section 316 and retransmission control signal generation section 319.

Control section 301 assigns downlink resources for transmitting control information (that is, downlink control information assignment resources) and downlink resources for transmitting downlink data included in the control information (that is, downlink data assignment resources) to resource assignment target terminal 400. This resources assignment is performed in a downlink unit band included in a unit band group set (configured) in resource assignment target terminal 400. Furthermore, downlink control information assignment resources are selected from among resources corresponding to a downlink control channel (PDCCH) in each downlink unit band. Furthermore, downlink data assignment resources are selected from among resources corresponding to a downlink data channel (PDSCH) in each downlink unit band. Furthermore, when there are a plurality of resource assignment target terminals 400, control section 301 assigns different resources to respective resource assignment target terminals 400.

Control section 301 sets a bundling unit band group made up of the downlink unit band and uplink unit band included in the unit band group in resource assignment target terminal 400 for initial transmission data to resource assignment target terminal 400. Since the number of downlink unit bands may be different from the number of uplink unit bands in this bundling unit band group (to be more specific, the number of uplink unit bands may be smaller than the number of downlink unit bands), the bundling unit band group may be asymmetric between the uplink and downlink. Furthermore, the setting of this bundling unit band group can be changed, for example, in subframe units. Furthermore, an uplink unit band included in the bundling unit band group forms a “unit band pair” with one of the downlink unit bands that belong to the same bundling unit band group. Furthermore, control section 301 sets a downlink unit band except the downlink unit band of the bundling unit band group in the unit band group in resource assignment target terminal 400 for retransmission data to resource assignment target terminal 400.

Furthermore, control section 301 determines a coding rate used to transmit control information to resource assignment target terminal 400. Since the amount of data of control information differs depending on this coding rate, control section 301 assigns downlink control information assignment resources having a number of CCEs capable of mapping control information of this amount of data.

Furthermore, control section 301 outputs information on downlink data assignment resources, NDI, DAI (Downlink Assignment Indicator) for notifying the number of downlink unit bands in the bundling unit band group (that is, the number of downlink unit bands to which downlink data is assigned) and PUCCH resource information indicating PUCCH resources to be used by a terminal to transmit a response signal using non-bundling to control information generation section 302. To be more specific, when an NDI for downlink data of each downlink unit band is 1 (that is, when the data is initial transmission data), control section 301 outputs both the NDI and DAI to control information generation section 302. On the other hand, when the NDI for downlink data of each downlink unit band is 0 (that is, when the data is retransmission data), control section 301 outputs both the NDI and PUCCH resource information to control information generation section 302. However, information on downlink data assignment resources is outputted in all cases.

Here, areas with the same number of bits and the same position in the control information format are assigned to the PUCCH resource information and DAI. That is, a common format can be used for control information of the downlink unit band in which initial transmission data is arranged and for control information of the downlink unit band in which retransmission data is arranged. Therefore, it is possible to reduce the number of times terminal 400 performs blind detection on the receiving side. Terminal 400 on the receiving side can decide whether information mapped in the area is PUCCH resource information or DAI according to the value of the NDI included together therewith in control information.

Furthermore, control section 301 outputs information on the coding rate to coding section 103. Furthermore, control section 301 determines a coding rate of transmission data (that is, downlink data) and outputs the coding rate to coding section 105.

Furthermore, control section 301 outputs information on the downlink data assignment resources and downlink control information assignment resources to mapping section 108. However, control section 301 performs control so that downlink data and downlink control information corresponding to the downlink data are mapped to the same downlink unit band.

Furthermore, control section 301 outputs a DAI to retransmission control signal generation section 319 and outputs PUCCH resource information to despreading section 315 and sequence control section 316.

Control information generation section 302 generates control information including information on downlink data assignment resources, NDI, and DAI or PUCCH resource information and outputs the control information to coding section 103. This control information is generated for each downlink unit band. Furthermore, a CRC bit masked with a terminal ID of the destination terminal is included in the control information as in the case of Embodiment 1. However, the DAI is included only in the control information transmitted in a downlink unit band included in the bundling unit band group set in resource assignment target terminal 200 (that is, downlink unit band in which the initial transmission data is arranged). Furthermore, the PUCCH resource information is only included in control information transmitted in the downlink unit band in which retransmission data is arranged.

Despreading section 315 despreads a response signal using a block-wise spreading code sequence used in terminal 400 for secondary spreading in each downlink unit band and outputs the despread response signal to correlation processing section 117.

Furthermore, despreading section 315 despreads the reference signal with an orthogonal sequence used to spread the reference signal in terminal 400 and outputs the despread reference signal to correlation processing section 117.

Sequence control section 316 generates a ZAC sequence commonly used for spreading of a plurality of response signals transmitted from terminal 400.

Furthermore, sequence control section 316 identifies a correlation window containing a signal component from terminal 400 based on code resources (e.g. amount of cyclic shift) used by terminal 400 for a response signal. To be more specific, about a bundled ACK/NACK signal which is a response signal for initial transmission data, sequence control section 316 identifies a correlation window based on component resources of the uplink control channel associated with the CCE of the downlink control channel in which initial transmission data is arranged. On the other hand, for a response signal for retransmission data, sequence control section 316 identifies a correlation window based on component resources of the uplink control channel associated with the CCE of the downlink control channel in which the retransmission data is arranged and PUCCH resource information.

Sequence control section 316 outputs information indicating the identified correlation window and the ZAC sequence generated to correlation processing section 117. This allows a response signal using bundling and a response signal using non-bundling transmitted through the uplink control channel of the same uplink unit band to be extracted respectively.

Retransmission control signal generation section 319 decides whether or not to retransmit data transmitted in each downlink unit band based on a plurality of response signals included in the received signal and generates a retransmission control signal based on the decision result.

That is, retransmission control signal generation section 319 receives a bundled ACK/NACK signal or DTX from decision section 118 corresponding to the uplink unit band in which a bundled ACK/NACK signal in the bundling unit band group is transmitted as in the case of Embodiment 1. However, in Embodiment 2 unlike Embodiment 1, since the response signal using bundling and response signal using non-bundling are transmitted through the uplink control channel of the same uplink unit band, retransmission control signal generation section 319 receives a response signal relating to the retransmission data or DTX from decision section 118 corresponding to the uplink unit band in which a bundled ACK/NACK signal is transmitted.

Retransmission control signal generation section 319 then controls retransmission of transmission data whose previous transmission was initial transmission based on the bundled ACK/NACK signal or DTX and also controls retransmission of transmission data whose previous transmission was also retransmission based on a response signal or DTX relating to retransmission data. To be more specific, as in the case of Embodiment 1, when receiving a bundled ACK/NACK signal indicating NACK or DTX, retransmission control signal generation section 319 generates a retransmission control signal indicating a retransmission command and outputs the retransmission control signal to data transmission control section 106 and also outputs an NDI indicating retransmission (that is, NDI bit=0) to control section 301. Furthermore, when receiving a bundled ACK/NACK signal indicating ACK, retransmission control signal generation section 319 generates a retransmission control signal indicating that retransmission will not be performed, outputs the retransmission control signal to data transmission control section 106 and also outputs an NDI indicating initial transmission (that is, NDI bit=1) to control section 301.

[Configuration of Terminal]

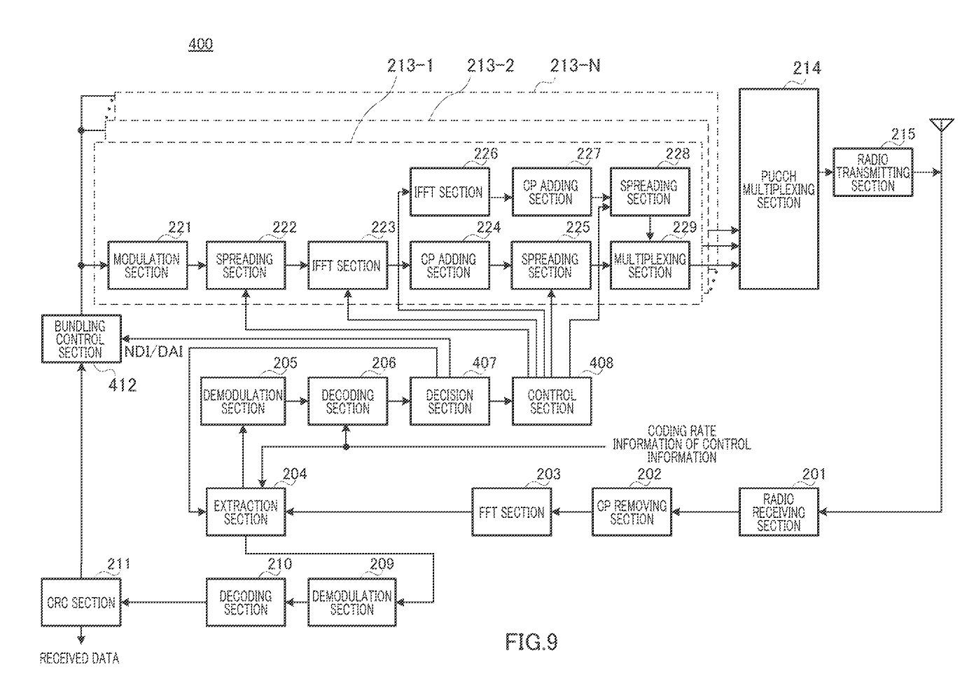

FIG. 9 is a block diagram showing a configuration of terminal 400 according to Embodiment 2 of the present invention. In FIG. 9, terminal 400 includes decision section 407, control section 408 and bundling control section 412.

Decision section 407 makes a blind detection as to whether control information included in a decoding result received from decoding section 206 is control information directed to the terminal or not. As described above, since the control information format is common between downlink unit bands, decision section 407 can make a blind detection without being aware of a distinction between a downlink unit band to which initial transmission data is mapped and a downlink unit band to which retransmission data is mapped. Decision section 407 then outputs information on downlink data assignment resources for the terminal included in control information directed to the terminal to extraction section 204.

Furthermore, decision section 407 extracts an NDI indicating whether downlink data directed to the terminal is initial transmission data or retransmission data from the control information of each downlink unit band and outputs the NDI to bundling control section 412. When the value of the extracted NDI is 1 (that is, initial transmission data is transmitted as downlink data in the downlink unit band in which control information from which the NDI is extracted is transmitted), decision section 407 extracts a DAI from the control information and outputs the DAI to bundling control section 412. On the other hand, when the value of the extracted NDI is 0 (that is, retransmission data is transmitted as downlink data in the downlink unit band in which control information from which the NDI is extracted is transmitted), decision section 407 extracts PUCCH resource information from control information and outputs the PUCCH resource information to control section 408. As described above, it is possible to decide whether the information mapped to the area having the same control information format is PUCCH resource information or DAI from the value of the NDI included together therewith in the control information.

Furthermore, decision section 407 identifies the downlink unit band to which the control information directed to the terminal is mapped and the CCE to which the control information directed to the terminal is mapped in the downlink unit band and outputs the identified downlink unit band and the identification information of CCE to control section 408.

Control section 408 identifies the PUCCH resources (frequency and code) through which a response signal should be transmitted from the downlink unit band indicated by the identification information of the downlink unit band received from decision section 407, CCE identification information, and PUCCH resource information. Control section 408 then outputs a ZAC sequence and amount of cyclic shift corresponding to the identified PUCCH resources about each downlink unit band to spreading section 222 of uplink control channel signal generation sections 213-1 to N corresponding to each downlink unit band and outputs frequency resource information to IFFT section 223. Furthermore, control section 408 outputs the ZAC sequence and frequency resource information as a reference signal to IFFT section 226, outputs a block-wise spreading code sequence to be used for secondary spreading of a response signal to spreading section 225 and outputs an orthogonal sequence to be used for secondary spreading of a reference signal to spreading section 228.

Bundling control section 412 generates a response signal to be transmitted from the terminal to base station 300 based on the reception condition of the downlink data transmitted in each downlink unit band included in the unit band group set in the terminal and the NDI and DAI received from decision section 407.

To be more specific, bundling control section 412 generates a bundled ACK/NACK signal as a response signal based on success/failure in receiving the downlink data received in the downlink unit band of the bundling unit band group set in the terminal (that is, initial transmission data). Bundling control section 412 outputs this bundled ACK/NACK signal to uplink control channel signal generation section 213 corresponding to one uplink unit band of the bundling unit band group. To be more specific, when the bundling unit band group includes a plurality of pieces of downlink data (that is, initial transmission data), bundling control section 412 calculates logical AND of the response signal on a plurality of pieces of downlink data, generates a bundled ACK/NACK signal and when the bundling unit band group includes only one piece of downlink data (that is, initial transmission data), bundling control section 412 assumes a response signal for the downlink data as a bundled ACK/NACK signal.

Furthermore, bundling control section 412 generates a response signal based on success/failure in receiving downlink data (that is, retransmission data) received in the downlink unit band of the remaining downlink unit band after excluding the component unit band of the bundling unit band group from the component unit band of the unit band group set in the terminal. In Embodiment 2, bundling control section 412 outputs this response signal to uplink control channel signal generation section 213, the same destination as for the bundled ACK/NACK signal. Uplink control channel signal generation section 213 code-spreads the bundled ACK/NACK signal and the response signal separately based on code resources to be used by the bundled ACK/NACK signal and the response signal for retransmission data respectively. Furthermore, uplink control channel signal generation section 213 performs IFFT in association with different frequency components based on the frequency resources to be used by the bundled ACK/NACK signal and the response signal for retransmission data.

[Operations of Base Station 300 and Terminal 400]

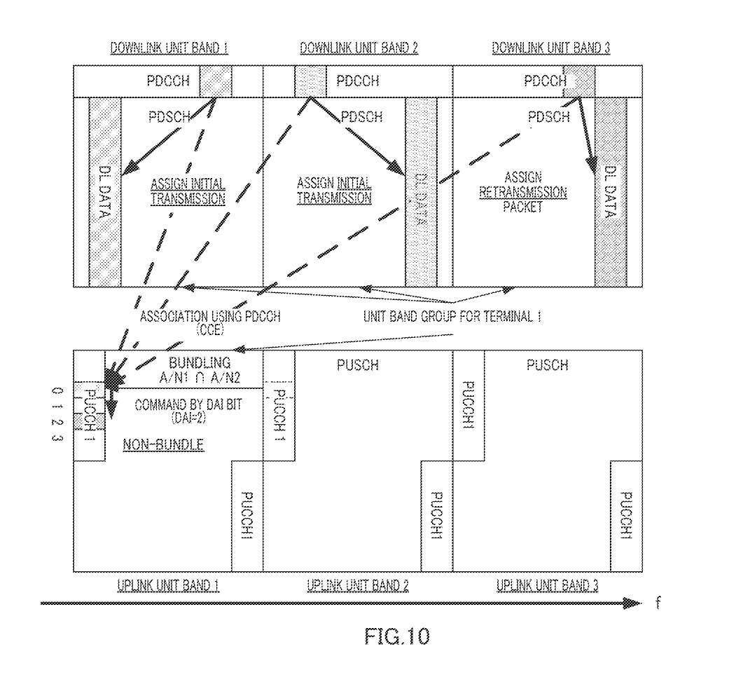

Operations of base station 300 and terminal 400 in the above described configurations will be described. FIG. 10 is a diagram illustrating operations of base station 300 and terminal 400.

<Resource Assignment Control and Transmission of Downlink Assignment Control Information and Downlink Data by Base Station 300>

In base station 300, control section 301 sets a bundling unit band group made up of downlink unit bands and uplink unit bands included in a unit band group in resource assignment target terminal 400 for initial transmission data to resource assignment target terminal 400. Since the number of downlink unit bands may be different from the number of uplink unit bands (to be more specific, the number of uplink unit bands may be smaller than the number of downlink unit bands), this bundling unit band group may be asymmetric between the uplink and the downlink. Furthermore, the uplink unit band included in the bundling unit band group forms a “unit band pair” with one of the downlink unit bands that belong to the same bundling unit band group. Furthermore, control section 301 sets downlink unit bands except the downlink unit bands of the bundling unit band group out of the unit band group in resource assignment target terminal 400 for the retransmission data to resource assignment target terminal 400.

Control section 301 outputs information on downlink data assignment resources, NDI, DAI (Downlink Assignment Indicator) for notifying the number of downlink unit bands in the bundling unit band group (that is, the number of downlink unit bands to which downlink data is assigned) and PUCCH resource information indicating PUCCH resources to be used by the terminal to transmit a response signal using non-bundling to control information generation section 302. To be more specific, when the NDI for downlink data of each downlink unit band is 1 (that is, when the data is initial transmission data), control section 301 outputs both the NDI and DAI to control information generation section 302. On the other hand, when the NDI for downlink data of each downlink unit band is 0 (that is, when the data is retransmission data), control section 301 outputs both the NDI and PUCCH resource information to control information generation section 302. However, information on downlink data assignment resources is outputted in all cases.

Base station 300 transmits downlink assignment control information in the downlink unit band group of the bundling unit band group set in destination terminal 400 (that is, downlink unit band group to which initial transmission data is mapped) and downlink unit band other than the downlink unit band group (that is, downlink unit band to which retransmission data is mapped) to downlink data destination terminal 400.

This will be described more specifically with reference to FIG. 10. In FIG. 10, an asymmetric unit band group made up of downlink unit bands 1, 2 and 3 and uplink unit band 1 is set for downlink data destination terminal 400. Furthermore, in FIG. 10, a bundling unit band group made up of downlink unit bands 1 and 2 and uplink unit band 1 is set for destination terminal 400 and downlink unit band 3 is set for transmission of retransmission data. Base station 300 then transmits downlink assignment control information in the downlink unit band group (that is, downlink unit bands 1 and 2) of the bundling unit band group set in destination terminal 400 and downlink unit band (that is, downlink unit band 3) set for transmission of retransmission data.

Base station 300 then transmits initial transmission data through downlink data channels of the downlink unit bands (that is, downlink unit bands 1 and 2) making up the bundling unit band group. Furthermore, base station 300 transmits retransmission data through a downlink data channel of downlink unit band 3.

<Response by Terminal 400>

In terminal 400, CRC section 211 performs error detection on downlink data corresponding to downlink assignment control information, the reception of which has been successful and outputs the error detection result to bundling control section 412.

Bundling control section 412 decides whether there is downlink control information, the reception of which has failed based on the DAI received from decision section 407 and the number of error detection results received from CRC section 211.

Furthermore, bundling control section 412 decides whether the downlink data in the plurality of pieces of downlink unit band received by terminal 400 is initial transmission data or retransmission data based on the NDI received from decision section 407.

Bundling control section 412 then generates a bundled ACK/NACK signal based on success/failure in receiving a downlink control signal transmitted in the downlink unit band of the bundling unit band group and an error detection result about the initial transmission data. To be more specific, when all error detection results for initial transmission data received from CRC section 211 show CRC=OK and it is decided that there is no downlink control information, the reception of which has failed, bundling control section 412 generates only one “ACK” as a bundled ACK/NACK signal and outputs the ACK to uplink control channel signal generation section 213 corresponding to the uplink unit band of the bundling unit band group. Furthermore, when even one of the plurality of pieces of initial transmission data results in CRC=NG or it is decided that there is downlink control information, the reception of which has failed, bundling control section 412 generates only one “NACK” as a bundled ACK/NACK signal and outputs the NACK to uplink control channel signal generation section 213 corresponding to the uplink unit band of the bundling unit band group. However, when the bundling unit band group includes only one initial transmission data and the error detection result for the initial transmission data is CRC=OK, bundling control section 412 generates “ACK” as a bundled ACK/NACK signal, and when the bundling unit band group includes only one piece of initial transmission data and the error detection result for the initial transmission data is CRC=NG, bundling control section 412 generates “NACK” as a bundled ACK/NACK signal and outputs the “NACK” to uplink control channel signal generation section 213 corresponding to the uplink unit band of the bundling unit band group.

Furthermore, bundling control section 412 generates a response signal based on the error detection result relating to the retransmission data. That is, a response signal for the retransmission data is generated independently without being bundled with the response signal for the initial transmission data as in the case of Embodiment 1. However, in Embodiment 2, a response signal for retransmission data is outputted to uplink control channel signal generation section 213, the same destination as for a bundled ACK/NACK signal.

Control section 408 identifies PUCCH resources (frequency and code) whereby a response signal should be transmitted from a downlink unit band indicated by identification information of the downlink unit band received from decision section 407, CCE identification information and PUCCH resource information. Control section 408 outputs the ZAC sequence and amount of cyclic shift corresponding to the identified PUCCH resources about each downlink unit band to spreading sections 222 of uplink control channel signal generation sections 213-1 to N corresponding to each downlink unit band and outputs the frequency resource information to IFFT section 223. Furthermore, control section 408 outputs the ZAC sequence and frequency resource information as a reference signal to IFFT section 226, outputs a block-wise spreading code sequence to be used for secondary spreading of a response signal to spreading section 225 and outputs an orthogonal sequence to be used for secondary spreading of the reference signal to spreading section 228.

Thus, a response signal using bundling (that is, bundled ACK/NACK signal) and a response signal using non-bundling (that is, response signal for retransmission data) are arranged in different resources of the same uplink control channel.

This will be described more specifically with reference to FIG. 10. Bundling control section 412 generates a bundled ACK/NACK signal based on the error detection result relating to the initial transmission data transmitted in the downlink unit band (that is, downlink unit bands 1 and 2 here) of the bundling unit band group. Bundling control section 412 then outputs the bundled ACK/NACK signal generated to uplink control channel signal generation section 213 corresponding to the uplink unit band (that is, uplink unit band 1) of the bundling unit band group. Uplink control channel signal generation section 213 then transmits an uplink control channel signal including the bundled ACK/NACK signal using resources set by control section 408. The resources are component resources of the uplink control channel of uplink unit band 1 associated with the CCE of the downlink control channel of downlink unit band 1.

In FIG. 10, the unit band group includes only one uplink unit band 1, but when the unit band group includes a plurality of uplink unit bands (e.g. uplink unit bands 1 and 2) (that is, when the unit band group is comprised of downlink unit bands 1, 2 and 3 and uplink unit bands 1 and 2), uplink unit band 2 that forms a unit band pair with downlink unit band 2 may also be selected as the uplink unit band of the bundling unit band group. In this case, bundling control section 412 outputs a bundled ACK/NACK signal to uplink control channel signal generation section 213 corresponding to uplink unit band 2. However, in FIG. 10, the bundling unit band group includes an uplink unit band (that is, uplink unit band 1) selected using, for example, an uplink unit band having the lowest frequency as a selection criterion out of a plurality of downlink unit bands making up a bundling unit band group (that is, downlink unit bands 1 and 2) and uplink unit band group which is the unit band pair (that is, uplink unit bands 1 and 2).

Furthermore, bundling control section 412 generates a response signal based on the error detection result relating to the retransmission data transmitted in downlink unit band 3. Bundling control section 412 then outputs a response signal for the retransmission data to uplink control channel signal generation section 213 as in the case of the bundled ACK/NACK signal. Uplink control channel signal generation section 213 then transmits an uplink control channel signal including a response signal for the retransmission data using the resources set by control section 408. The resources are component resources of the uplink control channel of uplink unit band 1 associated with the CCE and PUCCH resource information of the downlink control channel of downlink unit band 3. In this case, control section 408 arranges a response signal in resources having a resource index obtained by adding the number indicated by the PUCCH resource information to the resource index of uplink unit band 1 associated with a CCE of the downlink control channel of downlink unit band 3. Furthermore, the PUCCH resource information may also be a difference between the index of the resources in which the bundled ACK/NACK signal is arranged and the index of the resources in which the response signal for the retransmission data is arranged, for example, in the uplink control channel.

<Retransmission Control by Base Station 300>

In base station 300, retransmission control signal generation section 319 decides whether or not to retransmit data transmitted in each downlink unit band based on a plurality of response signals included in the received signal and generates a retransmission control signal based on the decision result. That is, retransmission control signal generation section 319 controls retransmission of the transmission data whose previous transmission was initial transmission based on the bundled ACK/NACK signal and also controls retransmission of transmission data whose previous transmission was also retransmission based on a response signal relating to the retransmission data.

As described above, according to the present embodiment, in base station 300, control information generation section 302 that generates downlink assignment control information transmitted in the downlink control channel of each downlink unit band includes data type information indicating initial transmission data and arrangement information indicating the number of downlink unit bands in which initial transmission data is arranged in the downlink assignment control information of the downlink unit band of the bundling unit band group, while control information generation section 302 includes data type information indicating the retransmission data and resource information indicating resources of the uplink control channel in which a response signal corresponding to the retransmission data is arranged (that is, PUCCH resource information) in the downlink unit band except the downlink unit band of the bundling unit band group.

By so doing, it is possible to equalize the information size (payload size) of the downlink assignment control information irrespective of the difference in the downlink unit band, and thereby achieve commonality of the format of the downlink assignment control information. As a result, it is possible to reduce the number of times terminal 400 performs blind detection on the receiving side.

Furthermore, by notifying PUCCH resource information in the downlink assignment control information for the retransmission data, it is possible to provide flexibility for resources to be used by a response signal for the retransmission data not to be bundled and thereby improve the degree of freedom of a scheduler.

Furthermore, in terminal 400, bundling control section 412 transmits a response signal for the retransmission data using other component resources in the uplink control channel through which a response signal corresponding to the initial transmission data is transmitted. The information for identifying the component resources is included in the PUCCH resource information.

Although the above descriptions have been given assuming the asymmetric unit band group as a premise, the present invention is not limited to this but the technique of the present embodiment is also applicable to a symmetric unit band group. In this case, the uplink unit band included in the bundling unit band group may be changed in subframe units.

### Embodiment 3

Embodiment 3 is different from Embodiment 2 particularly in response signal transmission control by a terminal. Hereinafter, differences from Embodiment 2 will be mainly described. Furthermore, descriptions will be given below assuming the following matters as premises. That is, asymmetric carrier aggregation peculiar to terminal 600 is constructed beforehand between base station 500 and terminal 600 and information of downlink unit bands and uplink unit bands to be used by terminal 600 is shared between base station 500 and terminal 600. Furthermore, a downlink unit band in which a BCH that broadcasts information on an uplink unit band making up a unit band group set (configured) in arbitrary terminal 600 by base station 500 and notified (signaled) to terminal 600 beforehand is transmitted is the “base unit band” for terminal 600. Information on this base unit band is “base unit band information.” Therefore, arbitrary terminal 600 can recognize this base unit band information by reading BCH information in each downlink unit band.

[Configuration of Base Station]

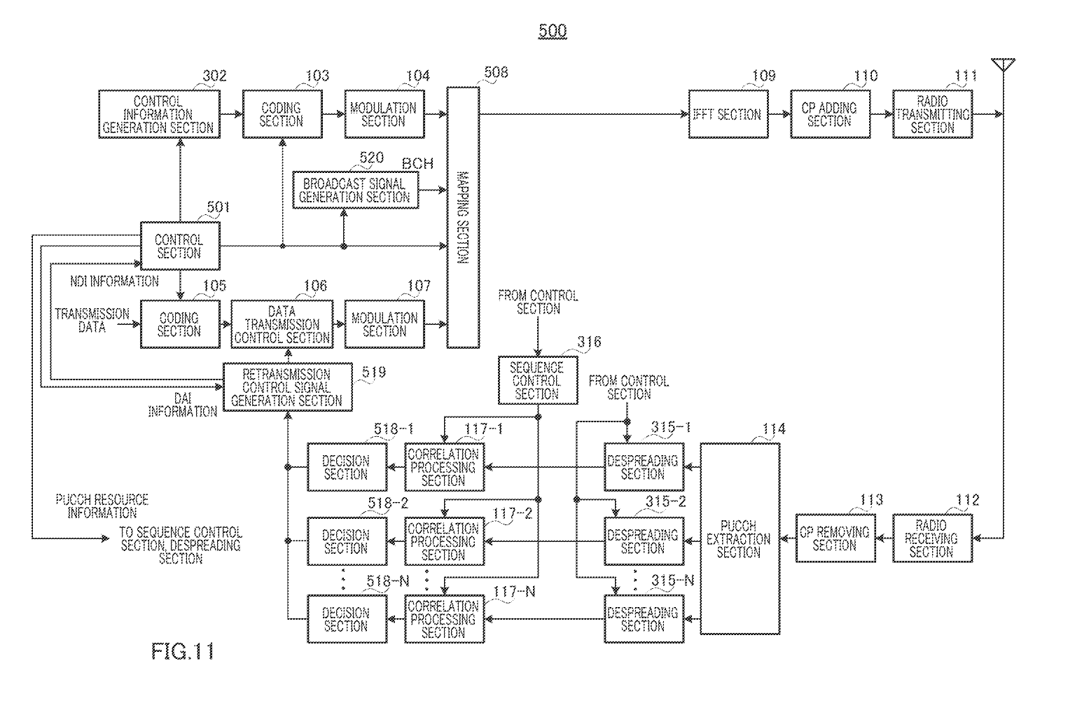

FIG. 11 is a block diagram showing a configuration of base station 500 according to Embodiment 3 of the present invention. In FIG. 11, base station 500 includes control section 501, mapping section 508, decision section 518, retransmission control signal generation section 519 and broadcast signal generation section 520.

Control section 501 has basically the same function as that of control section 301 of Embodiment 2. Control section 501 outputs a control signal for generating a broadcast channel signal (BCH) transmitted in each downlink unit band to broadcast signal generation section 520. Furthermore, control section 501 outputs base unit band information of each terminal 600 to retransmission control signal generation section 519.

Mapping section 508 has basically the same function as that of mapping section 108. Mapping section 508 further maps broadcast information to predetermined time/frequency resources and outputs the mapping result to IFFT section 109.

Broadcast signal generation section 520 generates a broadcast signal (BCH) for each downlink unit band according to a control signal received from control section 501 and outputs the broadcast signal to mapping section 508. This broadcast signal includes information of an uplink unit band that forms a unit band pair with the downlink unit band in which the broadcast signal is transmitted.

Decision section 518 decides whether a response signal transmitted from a terminal is ACK or NACK or DTX based on a correlation value inputted from correlation processing section 117. That is, when the scale of the correlation value inputted from correlation processing section 117 is a threshold or below, decision section 518 decides that terminal 600 transmits neither ACK nor NACK using the resources (DTX), and when the scale of the correlation value is the threshold or above, decision section 518 further decides which of ACK or NACK the response signal indicates through coherent detection. Decision section 518 then outputs ACK, NACK or DTX information for each terminal to retransmission control signal generation section 519.

Retransmission control signal generation section 519 decides whether or not to retransmit the data transmitted in each downlink unit band based on a plurality of response signals included in the received signal and generates a retransmission control signal based on the decision result.

That is, retransmission control signal generation section 519 receives a bundled ACK/NACK signal or DTX from decision section 518 corresponding to the uplink unit band in which the bundled ACK/NACK signal in the bundling unit band group is transmitted. Furthermore, since a response signal using bundling and a response signal using non-bundling are transmitted in through uplink control channels of the same uplink unit band, retransmission control signal generation section 519 receives a response signal relating to retransmission data or DTX from decision section 518 corresponding to the uplink unit band in which the bundled ACK/NACK signal is transmitted.

Retransmission control signal generation section 519 then controls retransmission of transmission data whose previous transmission was initial transmission based on the bundled ACK/NACK signal or DTX and controls retransmission of transmission data whose previous transmission was also retransmission based on the response signal relating to the retransmission data or DTX.

[Configuration of Terminal]

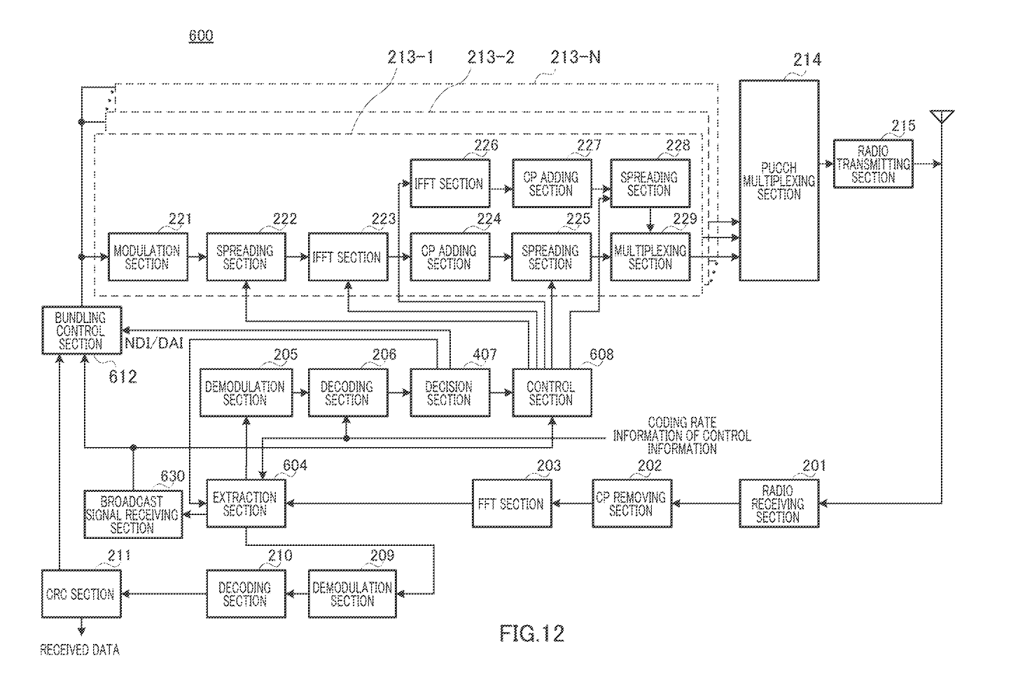

FIG. 12 is a block diagram showing a configuration of terminal 600 according to Embodiment 3 of the present invention. In FIG. 12, terminal 600 includes extraction section 604, control section 608, bundling control section 612 and broadcast signal receiving section 630.

Extraction section 604 has basically the same function as that of above extraction section 204. Extraction section 604 further extracts a broadcast signal from a received signal receives from FFT section 203 and outputs the broadcast signal to broadcast signal receiving section 630. Since resources to which a broadcast signal is mapped is predetermined, extraction section 604 extracts information mapped to the resources. Furthermore, the extracted broadcast signal includes information relating to the association between each downlink unit band and uplink unit band.

Broadcast signal receiving section 630 decodes a broadcast signal included in each downlink unit band and extracts information of an uplink unit band that forms a unit band pair with each downlink unit band (that is, information of uplink unit band notified by SIB 2 mapped to each downlink unit band). Furthermore, broadcast signal receiving section 630 recognizes a downlink unit band that forms a pair with the uplink unit band included in the unit band group to which the terminal belongs as “base unit band” and outputs the base unit band information to bundling control section 612 and control section 608.

Control section 608 identifies PUCCH resources (frequency and code) whereby a response signal should be transmitted from a downlink unit band indicated by the identification information of the downlink unit band received from decision section 407, CCE identification information and PUCCH resource information. Control section 608 outputs a ZAC sequence and amount of cyclic shift corresponding to the identified PUCCH resources about each downlink unit band to spreading section 222 of uplink control channel signal generation sections 213-1 to N corresponding to each downlink unit band and outputs frequency resource information to IFFT section 223. Furthermore, control section 608 outputs the ZAC sequence and frequency resource information as a reference signal to IFFT section 226, outputs a block-wise spreading code sequence to be used for secondary spreading of the response signal to spreading section 225 and outputs an orthogonal sequence to be used for secondary spreading of the reference signal to spreading section 228.

Bundling control section 612 generates a response signal to be transmitted from the terminal to base station 500 based on a reception condition of downlink data transmitted in each downlink unit band included in the unit band group set in the terminal, base unit band information received from broadcast signal receiving section 630 and an NDI and DAI received from decision section 407. Bundling control section 612 outputs the response signal generated to uplink control channel signal generation section 213 corresponding to the uplink unit band that forms a unit band pair with the base unit band. The transmission control over a response signal will be described in detail later.

[Operations of Base Station 500 and Terminal 600]

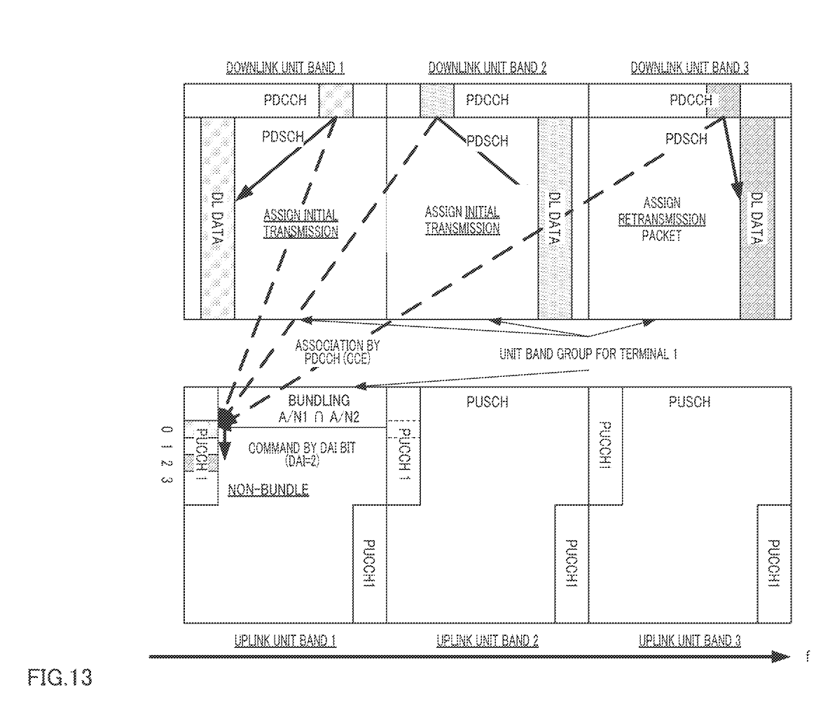

Operations of base station 500 and terminal 600 in the above described configurations will be described. FIG. 13 is a diagram illustrating operations of base station 500 and terminal 600.

<Resources Assignment Control and Transmission of Downlink Assignment Control Information and Downlink Data by Base Station 500>

In base station 500, control section 501 sets a bundling unit band group made up of downlink unit bands and uplink unit bands included in a unit band group in resource assignment target terminal 600 for initial transmission data to resource assignment target terminal 600. Since the number of downlink unit bands is different from the number of uplink unit bands (to be more specific, the number of uplink unit bands is smaller than the number of downlink unit bands), the bundling unit band group may be asymmetric between the uplink and downlink. Furthermore, the setting of this bundling unit band group can be changed, for example, in subframe units. Furthermore, an uplink unit band included in the bundling unit band group forms a “unit band pair” with one of the downlink unit bands that belong to the same bundling unit band group. Furthermore, a downlink unit band in which a BCH that broadcasts information on the uplink unit band included in the bundling unit band group is transmitted is a “base unit band” for resource assignment target terminal 600. In other words, the downlink unit band in which a BCH that broadcasts information on the uplink unit band used to transmit a response signal using bundling is transmitted is the “base unit band” for resource assignment target terminal 600.

Furthermore, for retransmission data to resource assignment target terminal 600, control section 501 sets a downlink unit band except the downlink unit band of the bundling unit band group in the unit band group for resource assignment target terminal 600.

Control section 501 stores information on the base unit band (that is, the base unit band in the bundling unit band group) in the unit band group set for each terminal 600. When transmitting initial transmission data to terminal 600, control section 501 uses the base unit band for terminal 600 in question with high priority. That is, when the base station 500 side transmits one piece of data (transport block: also called “TB”) of initial transmission to terminal 600, control section 501 performs control of mapping the data to the base unit band for terminal 600 in question and also generates DAI bit information for notifying that there is no downlink unit band other than the base unit band (that is, no initial transmission data other than the base unit band is arranged) in the bundling unit band group to terminal 600. This DAI bit is outputted to control information generation section 302 from control section 501 together with the other control information and transmitted in the same downlink unit band as that of the downlink data. Furthermore, when the base station 500 side simultaneously transmits data of two or more pieces of initial transmission data to terminal 600, control section 501 always performs control so as to map one piece of data to the base unit band of terminal 600 and map the remaining data to the downlink unit band except the base unit band in the bundling unit band group. Control section 501 generates DAI bit information to notify that the bundling unit band group includes a downlink unit band other than the base unit band (that is, initial transmission data other than the base unit band is arranged) to terminal 600 and outputs the DAI bit information to control information generation section 302. This DAI bit is included in the downlink assignment control information transmitted in the base unit band and notified to terminal 600.

Base station 500 transmits downlink assignment control information in the downlink unit band used to transmit downlink data (initial transmission data and retransmission data) in the unit band group set in downlink data destination terminal 600 in question to destination terminal 600. Furthermore, base station 500 notifies the number of downlink unit bands other than the base unit band in the bundling unit band group (that is, the number of downlink unit bands other than the base unit band in which downlink data is arranged) to destination terminal 600 using a DAI included in the downlink assignment control information transmitted in the base unit band.

Explaining this more specifically with reference to FIG. 13, a unit band group made up of downlink unit bands 1, 2 and 3 and uplink unit band 1 are set in destination terminal 600. The bundling unit band group is made up of downlink unit bands 1 and 2 and uplink unit band 1. Here, when communication using carrier aggregation is applied to destination terminal 600, base station 500 transmits downlink assignment control information using downlink unit bands 1, 2 and 3. To transmit this downlink assignment control information, base station 500 assigns a subchannel (that is, L1/L2 CCH) included in a downlink control channel (PDCCH) of the downlink unit band to destination terminal 600 and transmits the downlink assignment control information to destination terminal 600 using the assigned subchannel. Each subchannel is made up of one or a plurality of CCEs.

<Reception of Downlink Data by Terminal 600>

In terminal 600, broadcast signal receiving section 630 identifies, as a base unit band, a downlink unit band in which a BCH is transmitted which broadcasts information on an uplink unit band making up the unit band group notified to terminal 600.

Furthermore, decision section 407 decides whether the downlink control channel of each downlink unit band contains downlink assignment control information directed to the terminal or not and outputs the downlink assignment control information directed to the terminal to extraction section 604.

Extraction section 604 extracts downlink data from the received signal based on the downlink assignment control information received from decision section 407.

Thus, terminal 600 can receive downlink data transmitted from base station 500.

Describing more specifically with reference to FIG. 13, since a BCH that broadcasts information on uplink unit band 1 is transmitted in downlink unit band 1, downlink unit band 1 becomes the base unit band of terminal 600.

Furthermore, downlink assignment control information transmitted in downlink unit band 1 includes information on resources used to transmit downlink data (DL data) transmitted in downlink unit band 1, downlink assignment control information transmitted in downlink unit band 2 includes information on resources used to transmit downlink data transmitted in downlink unit band 2 and downlink assignment control information transmitted in downlink unit band 3 includes information on resources used to transmit downlink data (DL data) transmitted in downlink unit band 3.

Therefore, terminal 600 receives the downlink assignment control information transmitted in downlink unit band 1, the downlink assignment control information transmitted in downlink unit band 2 and the downlink assignment control information transmitted in downlink unit band 3, and can thereby receive downlink data in all downlink unit band 1, downlink unit band 2 and downlink unit band 3. Conversely, when terminal 600 cannot receive the downlink assignment control information, terminal 600 cannot receive the downlink data.

Furthermore, terminal 600 can recognize that downlink assignment control information is transmitted not only in downlink unit band 1 which is the base unit band but also in downlink unit band 2 through a DAI transmitted in downlink unit band 1.

<Response by Terminal 600>

As in the case of Embodiment 2, response control over initial transmission data and response control over retransmission data are performed separately.

(1) Response to Initial Transmission Data

Bundling control section 612 performs the following transmission control over a response signal based on an error detection result received from CRC section 211, DAI received from control section 608 and base unit band information received from broadcast signal receiving section 630.

When bundling control section 612 receives error detection results corresponding to the same number of pieces of initial transmission data as the downlink data calculated from the DAI from CRC section 211 (that is, when the reception of downlink assignment control information for initial transmission data has been successful in all downlink unit bands of the bundling unit band group), bundling control section 612 transmits a bundled ACK/NACK signal which bundles all these error detection results into one signal to base station 500.

Upon succeeding in receiving downlink assignment control information in the base unit band, bundling control section 612 receives the error detection result about the downlink data transmitted in the base unit band from CRC section 211, but when the total number of error detection results received from CRC section 211 is smaller than the number of pieces of initial transmission data calculated from the DAI, bundling control section 612 transmits NACK as a bundled ACK/NACK signal. NACK is assumed to be transmitted here, but the response signal itself may also be assumed not to be transmitted. This is because, even when terminal 600 does not transmit any response signal, base station 500 performs retransmission control assuming that as DTX, and therefore the same retransmission control as that when NACK is transmitted is performed as a consequence.

Furthermore, not only when bundling control section 612 does not receive the error detection result itself for the initial transmission data from CRC section 211 (that is, terminal 600 does not succeed in receiving any downlink assignment control information in the bundling unit band group) but also when bundling control section 612 receives only the error detection result about the initial transmission data transmitted in a downlink unit band other than the base unit band (that is, reception of the downlink assignment control information for the initial transmission data has not been successful in the base unit band), bundling control section 612 does not transmit the bundled ACK/NACK signal for the initial transmission data to base station 500.

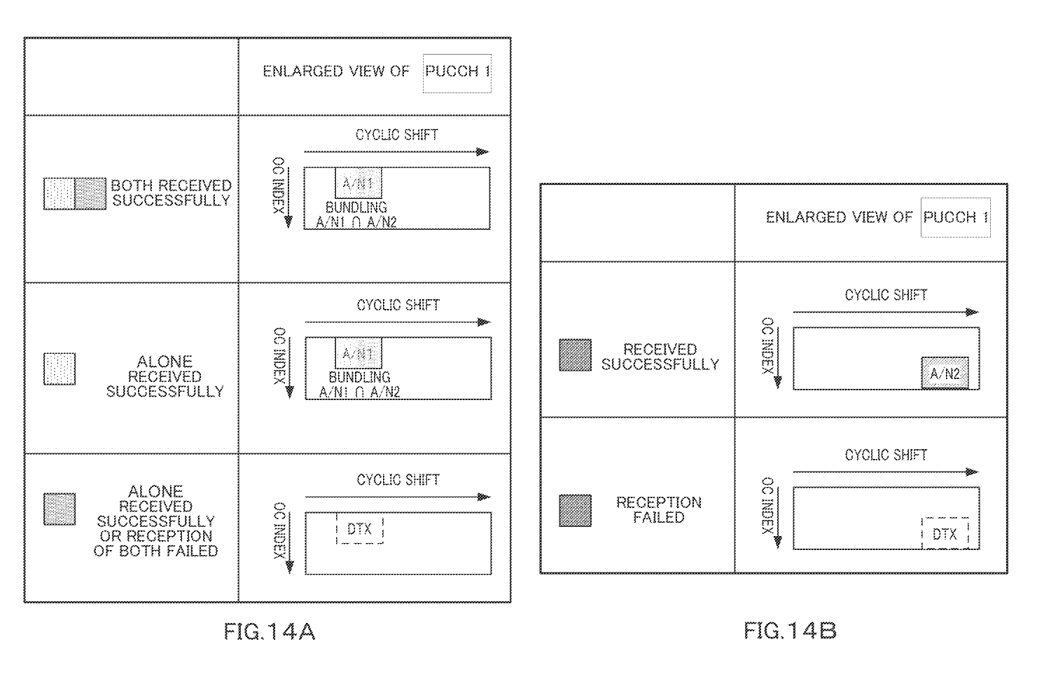

Transmission control over the bundled ACK/NACK signal for the initial transmission data will be described more specifically with reference to FIG. 14. FIG. 14A presupposes that carrier aggregation is applied to communication between base station 500 and terminal 600.

Upon succeeding in receiving both downlink assignment control information for initial transmission data transmitted in downlink unit band 1 and downlink assignment control information for initial transmission data transmitted in downlink unit band 2, bundling control section 612 transmits a response signal based on the error detection result of downlink data received using the resources indicated by both pieces of downlink assignment control information (that is, the bundled ACK/NACK signal) using PUCCH 1 conventionally provided as uplink control channel resources corresponding to downlink unit band 1.

Furthermore, upon succeeding in receiving only downlink assignment control information for initial transmission data transmitted in downlink unit band 1, bundling control section 612 transmits NACK using PUCCH 1.

Furthermore, bundling control section 612 does not transmit any bundled ACK/NACK signal not only when failing to receive both downlink assignment control information for initial transmission data transmitted in downlink unit band 1 and downlink assignment control information for initial transmission data transmitted in downlink unit band 2, but also when succeeding in receiving only downlink assignment control information transmitted in downlink unit band 2. This eliminates the need to secure new resources for an uplink control channel corresponding to the association between downlink unit band 2 and uplink unit band 1 in the unit band group. As a result, overhead of the uplink control channel can be reduced.

Even when the above described response signal transmission control is performed, if the reception of even one piece of downlink data arranged in the downlink unit band fails in the ACK/NACK bundling operation in the first place, NACK is transmitted from the terminal and the base station side is presupposed to retransmit all the downlink data accordingly, and therefore the retransmission efficiency in ACK/NACK bundling never deteriorates.

Furthermore, by performing the above described response signal transmission control over initial transmission data, it is possible to use resources for the uplink control channel used in the band pair of one downlink unit band and one uplink unit band set in a terminal having no capability to perform communication through carrier aggregation, also for the unit band group including this band pair. This is guaranteed by defining the base unit band as the downlink unit band in which a BCH is arranged which broadcasts information of the uplink unit band of the unit band group in asymmetric carrier aggregation individually configured by the base station for the terminal. Therefore, although performing asymmetric carrier aggregation produces a new association between the downlink unit band and the uplink unit band, it is not necessary to secure new resources for the uplink control channel supporting this association and it is thereby possible to reduce overhead of the uplink control channel. Furthermore, since the association between the downlink unit band in the band pair set for the terminal having no capability to perform communication through carrier aggregation and resources for the uplink control channel corresponding thereto is also maintained, it is possible to realize a system in which terminals having a capability to perform communication through carrier aggregation and terminals having no capability to perform communication through carrier aggregation can coexist.

(2) Response to Retransmission Data

As shown in FIG. 14B, upon succeeding in receiving downlink assignment control information in a downlink unit band (in FIG. 13, downlink unit band 3) assigned to transmission of retransmission data, bundling control section 612 transmits a response signal based on the error detection result of the downlink data received using the resources indicated by the downlink assignment control information to base station 500.

On the other hand, upon failing to receive the downlink assignment control information in the downlink unit band assigned to transmission of retransmission data, bundling control section 612 does not transmit any response signal.

Performing the above described response signal transmission control over retransmission data requires additional PUCCH resources for the retransmission data, but since the probability that retransmission will occur is on the order of 10% in the first place, and it is therefore possible to suppress an increase in overhead to a minimum. Furthermore, since PUCCH resource information is notified to terminals as in the case of Embodiment 2, it is possible to provide flexibility for the method of using response signal resources for retransmission data and improve the degree of freedom of a scheduler.

As described above, according to the present embodiment, in terminal 600, when bundling control section 612 succeeds in receiving downlink assignment control information transmitted in a base unit band which is a downlink unit band whereby a broadcast channel signal containing information on an uplink unit band in a bundling unit band group is transmitted and a second downlink unit band other than the base unit band in which initial transmission data is arranged in extraction section 604, demodulation section 205 and decoding section 206 as a control information receiving section, bundling control section 612 transmits a response signal for the initial transmission data (that is, bundled ACK/NACK signal) using resources of the uplink control channel provided in the uplink unit band in association with the downlink control channel in the base unit band and when the control information receiving section succeeds in receiving only the downlink assignment control information transmitted in the second downlink unit band, bundling control section 612 does not transmit any response signal for the initial transmission data to base station 500.

This eliminates the need to secure new resources for an uplink control channel corresponding to the association between the downlink unit band other than the base unit band and the uplink unit band that forms a band pair with the base unit band in the unit band group, and can thereby reduce overhead of the uplink control channel.

A case has been described above as a premise where only one uplink unit band is included in a unit band group in asymmetric carrier aggregation configured for terminal 600. However, the present embodiment is not limited to this. That is, when a plurality of uplink unit bands are included in the unit band group, base station 500 commands terminal 600 as to which uplink unit band to use to transmit an uplink response signal. Even when a plurality of uplink unit bands are included in a unit band group for certain terminal 600, if a downlink unit band that transmits a BCH for broadcasting information of the uplink unit band commanded from base station 500 to use for transmission of the uplink response signal is assumed to be a base unit band for terminal 600, it is possible to maintain the above described effects.

Although an asymmetric unit band group has been described above as a premise, the present embodiment is not limited to this but the technique of the present embodiment is also applicable to a symmetric unit band group. In this case, the uplink unit band included in the bundling unit band group may be changed in subframe units.

### Other Embodiments

(1) In Embodiments 1 to 3, when retransmission data is transmitted in a plurality of downlink unit bands, response signals for retransmission data may also be bundled. That is, in Embodiment 1, a second bundling unit band group for retransmission data is set in addition to a first bundling unit band group for initial transmission data and a bundled ACK/NACK signal is arranged in the uplink control channel of the uplink unit band of the second bundling unit band group. On the other hand, in Embodiments 2 and 3, a bundled ACK/NACK signal for retransmission data is arranged in resources indicated by PUCCH resource information. By so doing, it is possible to further suppress the amount of resources used in the uplink control channel, and thereby reduce power consumption of terminals and further reduce interference in the uplink control channel. Furthermore, even in the case of retransmission data, the error rate differs depending on a retransmission count, and therefore only response signals for retransmission data having the same RV commanded value (the retransmission count is reflected) may be bundled.

(2) Furthermore, the ZAC sequence in the above described embodiments may be called “base sequence” in the sense of a sequence that serves as a basis for applying cyclic shift processing.

Furthermore, the Walsh sequence may also be called “Walsh code sequence.”

(3) Furthermore, a case has been described in the above described embodiments where secondary spreading is performed after primary spreading and IFFT conversion as the sequence of processing on the terminal side. However, the processing sequence is not limited to this. That is, since both primary spreading and secondary spreading are multiplication processing, equivalent results may be obtained no matter where the secondary spreading processing is located as long as the IFFT processing is located after the primary spreading processing.

(4) Furthermore, although cases have been described with the embodiments above where the present invention is configured by hardware, the present invention may be implemented by software.

Each function block employed in the description of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-106332, filed on Apr. 24, 2009, including the specification, drawings and abstract, is incorporated herein by reference in its entirety.

### INDUSTRIAL APPLICABILITY

The base station apparatus and terminal apparatus of the present invention are suitable for use in realizing retransmission control with high flexibility while suppressing increases in overhead of uplink control channels.

### REFERENCE SIGNS LIST

100, 300, 500 Base station
101, 208, 301, 408, 501, 608 Control section
102, 302 Control information generation section
103, 105 Coding section
104, 107, 221 Modulation section
106 Data transmission control section
108, 508 Mapping section
109, 223, 226 IFFT section
110, 224, 227 CP adding section
111, 215 Radio transmitting section
112, 201 Radio receiving section
113, 202 CP removing section
114 PUCCH extraction section
115, 315 Despreading section
116, 316 Sequence control section
117 Correlation processing section
118, 207, 407, 518 Decision section
119, 319, 519 Retransmission control signal generation section
200, 400, 600 Terminal
203 FFT section
204, 604 Extraction section
205, 209 Demodulation section
206, 210 Decoding section
211 CRC section
212, 412, 612 Bundling control section
213 Uplink control channel signal generation section
214 PUCCH multiplexing section
222, 225, 228 Spreading section
229 Multiplexing section
520 Broadcast signal generation section
630 Broadcast signal receiving section

1. A terminal apparatus that communicates with a base station using a unit band group made up of N (N is a natural number equal to 2 or greater) downlink unit bands and uplink unit bands and transmits a response signal based on an error detection result of downlink data arranged in a downlink unit band through an uplink control channel of an uplink unit band corresponding to the downlink unit band, comprising:
a control information receiving section that receives downlink assignment control information transmitted through downlink control channels of the plurality of downlink unit bands;
a downlink data receiving section that receives the downlink data transmitted through a downlink data channel indicated by the downlink assignment control information;
an error detection section that detects a reception error of the received downlink data;
a decision section that decides whether the downlink data received in each downlink unit band is initial transmission data or retransmission data; and
a response control section that controls transmission of a response signal used for retransmission control of the downlink data in the base station based on the error detection result obtained in the error detection section, success/failure in the reception of the downlink assignment control information and the decision result,
wherein the response control section transmits a response signal for the initial transmission data using component resources of an uplink control channel, the component resources being provided in the uplink unit band, and the component resources being associated with the downlink control channel of the downlink unit band in which the initial transmission data is transmitted, and transmits a response signal for the retransmission data using resources different from resources of a response signal for the initial transmission data.

2. The terminal apparatus according to claim 1, wherein when a plurality of pieces of the initial transmission data exist, the response control section generates only one bundled response signal for the plurality of pieces of initial transmission data and transmits the generated bundled response signal using component resources of the uplink control channel, the component resources being provided in the uplink unit band, and the component resources being associated with the downlink control channel of the downlink unit band in which one of the plurality of pieces of initial transmission data is transmitted.

3. The terminal apparatus according to claim wherein the response control section transmits a response signal for the retransmission data using component resources of the uplink control channel, the component resources being provided in another uplink unit band, and the component resources being associated with the downlink control channel of the downlink unit band in which the retransmission data is transmitted.

4. The terminal apparatus according to claim 1, wherein the response control section transmits a response signal for the retransmission data using another component resources in the uplink control channel in which a response signal corresponding to the initial transmission data is transmitted.

5. The terminal apparatus according to claim wherein the response control section transmits, when the control information receiving section succeeds in receiving downlink assignment control information transmitted in a base unit band and a second downlink unit band in which initial transmission data is arranged, a response signal for the initial transmission data using resources of an uplink control channel, the resources being provided in the uplink unit band, and the resources being associated with the downlink control channel of the base unit band, and does not transmit the response signal for the initial transmission data to the base station when the control information receiving section succeeds in receiving only downlink assignment control information transmitted in the second downlink unit band, the base unit band being a downlink unit band in which a broadcast channel signal containing information on an uplink unit band of the unit band group is transmitted, and the second downlink unit band being a downlink unit band other than the base unit band.

6. A base station apparatus that communicates with a terminal using a unit band group made up of N (N is a natural number equal to 2 or greater) downlink unit bands and uplink unit bands, comprising:
a control section that sets a bundling unit band group from among the N downlink unit bands; and
a mapping section that maps initial transmission data in downlink data to the downlink unit bands of the bundling unit band group and also maps retransmission data to downlink unit bands other than the downlink unit band of the bundling unit band group out of the N downlink unit bands.

7. The base station apparatus according to claim 6, further comprising a control information generation section that generates downlink assignment control information transmitted through a downlink control channel of each downlink unit band, the downlink assignment control information of the downlink unit band of the bundling unit band group including data type information indicating initial transmission data and arrangement information indicating the number of downlink unit bands in which initial transmission data is arranged, and the downlink assignment control information of a downlink unit band other than the downlink unit band of the bundling unit band group including data type information indicating retransmission data and resource information indicating resources of the uplink control channel in which a response signal corresponding to retransmission data has to be arranged.
